(19) United States
(12) Patent Application Publication
(10) Pub. No.: US 2026/0349674 A1
(43) Pub. Date: Nov. 5, 2026

(54) USAGE PATTERN RECOMMENDATION FOR DIGITAL ARTIFACTS

(71) Applicant: Infosys Limited, Bangalore (IN)

(72) Inventors: Rajeshwari Ganesan, Bellevue, WA (US); Debrup Dey, Bengaluru (IN); Shubham Aggarwal, London (GB); Akshatha Miyal Kamath, Bengaluru (IN)

(73) Assignee: Infosys Limited, Bangalore (IN)

(21) Appl. No.: 19/370,017

(22) Filed: Oct. 27, 2025

Related U.S. Application Data
(60) Provisional application No. 63/771,444, filed on Mar. 13, 2025.

(51) Int. Cl. G06F 8/34

(52) U.S. Cl. CPC G06F 8/34

(57) ABSTRACT

A system for usage pattern recommendation for digital artifacts is provided. The system includes a storage element that stores a set of digital artifacts and processing circuitry coupled thereto. The processing circuitry determines a plurality of operational attribute values for a plurality of operational attributes pertaining to each of a plurality of operations associated with at least a first digital artifact. The processing circuitry generates a first set of digital pheromone trails associated with at least the first digital artifact. The processing circuitry determines a first usage score associated with each digital pheromone trail. The processing circuitry generates a first cluster for a first digital pheromone trail. The processing circuitry determines, based on the first cluster, a first recommended usage pattern associated with at least the first digital artifact. The processing circuitry renders, via a display device associated with the system, the first recommended usage pattern.

### CROSS-REFERENCE TO RELATED APPLICATIONS

The present application is related to and claims priority to U.S. patent application Ser. No. 63/771,444, filed on Mar. 13, 2025, and entitled “LEGACY CODE MODERNIZATION”, the contents of which are incorporated herein by reference.

### FIELD OF THE DISCLOSURE

Various embodiments of the present disclosure relate generally to navigation among digital artifacts. More specifically, various embodiments of the present disclosure relate to determination of usage pattern recommendations for navigation among digital artifacts associated with a software product using artificial intelligence.

### BACKGROUND

Software products are composed of multiple interconnected digital artifacts, such as source code files, configuration scripts, design documents, user interfaces, databases, and APIs. Each of these digital artifacts is accessed and manipulated by different stakeholders, including developers, testers, designers, project managers, and end-users, depending on their roles and responsibilities within a software lifecycle. These stakeholders interact with the digital artifacts in various capacities, performing specific tasks or operations that contribute to the creation, maintenance, and evolution of the software product.

During the execution of their tasks, stakeholders often navigate through different digital artifacts or interact with multiple software components in a sequential or iterative manner. This sequence of interactions or transitions can be conceptualized as a navigation pattern, representing how a stakeholder moves from one artifact to another to accomplish a particular goal. However, the navigation paths followed by different stakeholders for the same goal may vary significantly depending on their experience, familiarity with the software products, access permissions, or individual working strategies.

While some of these navigation paths may be more optimal or performant, others may be suboptimal and less efficient, hence, may lead to redundant actions, higher memory consumption, or unnecessary complexity. Often, the discovery of such optimal paths results from years of experience and repeated interactions with the software products, making it difficult for less experienced stakeholders to replicate or benefit from these efficient strategies.

This variability introduces several challenges, including inefficient use of resources, skill gaps among team members, and reduced overall performance of the software products. As software products grow in complexity, the inability to identify and disseminate performant navigation patterns may lead to substantial inefficiencies in development and maintenance processes. Therefore, it becomes important to identify, model, and recommend optimal paths or navigation patterns that stakeholders can utilize for specific tasks.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for facilitating usage pattern recommendation for digital artifacts are provided substantially as shown in, and described in connection with, at least one of the figures.

In an embodiment of the present disclosure, a system, which is a usage pattern recommendation system, is disclosed. The usage pattern recommendation system includes a storage element and processing circuitry coupled thereto. The storage element is configured to store a set of digital artifacts. The processing circuitry is configured to determine a first plurality of operational attribute values for a plurality of operational attributes pertaining to each of a first plurality of operations associated with at least a first digital artifact of the set of digital artifacts. The processing circuitry is further configured to generate, based on the first plurality of operational attribute values for the plurality of operational attributes pertaining to each of the first plurality of operations, a first set of digital pheromone trails associated with at least the first digital artifact. The first set of digital pheromone trails represents a first set of navigation patterns associated with at least the first digital artifact. The processing circuitry is further configured to determine, based on the first plurality of operational attribute values, a first usage score associated with each digital pheromone trail of the first set of digital pheromone trails. The first usage score is indicative of traversal frequency of a navigation pattern associated with the digital pheromone trail. The processing circuitry is further configured to generate a first cluster for a first digital pheromone trail of the first set of digital pheromone trails based on the first usage score associated with the first digital pheromone trail exceeding a first threshold usage score. The first cluster includes at least the first digital artifact. The processing circuitry is further configured to determine, based on the first cluster, a first recommended usage pattern associated with at least the first digital artifact. The first recommended usage pattern is indicative of a first navigation pattern, of the first set of navigation patterns, represented by the first digital pheromone trail. The processing circuitry is further configured to render, via a display device associated with the system, the first recommended usage pattern.

In some embodiments, the processing circuitry is further configured to detect a traversal operation associated with the first recommended usage pattern. The processing circuitry is further configured to increment, based on the detection of the traversal operation, the first usage score associated with the first digital pheromone trail in accordance with an activation function. The processing circuitry is further configured to continuously decrement the first usage score in accordance with an evaporation function associated with the first recommended usage pattern.

In some embodiments, the plurality of operational attributes include at least two of: a functional attribute associated with at least the first digital artifact, a non-functional attribute associated with at least the first digital artifact, or a hidden attribute associated with at least the first digital artifact.

In some embodiments, the storage element is further configured to store at least one of: a navigator agent, a cluster agent, a visualization agent, an adaptive agent, or a function-specific agent.

In some embodiments, the processing circuitry is further configured to utilize the navigator agent to generate the first set of digital pheromone trails. The navigator agent is configured to determine operational metadata corresponding to the first plurality of operations associated with at least the first digital artifact. The first plurality of operational attribute values for the plurality of operational attributes is determined based on the operational metadata. The navigator agent is configured to generate, based on at least one of: the first plurality of operational attribute values or the operational metadata, the first set of digital pheromone trails.

In some embodiments, the processing circuitry is further configured to utilize the cluster agent to generate the first cluster. The cluster agent is configured to acquire the first plurality of operational attribute values for the plurality of operational attributes from the navigator agent. The cluster agent is further configured to determine, based on the first plurality of operational attribute values, at least one of: the first usage score associated with the first digital pheromone trail or a first recency score associated with the first digital pheromone trail. The first recency score is indicative of a time-instance of a most recent traversal of the first navigation pattern associated with the first digital pheromone trail. The cluster agent is further configured to generate, based on at least one of: the first usage score associated with the first digital pheromone trail or the first recency score, the first cluster for the first digital pheromone trail. The first recency score exceeds a recency threshold score.

In some embodiments, the processing circuitry is further configured to utilize the function-specific agent for the determination of the first recommended usage pattern. The function-specific agent is configured to receive, from the cluster agent, at least one of: the first cluster or a set of metadata associated with the first cluster. The set of metadata is indicative of a navigation pattern type indicated by the first cluster. The function-specific agent is further configured to determine the first recommended usage pattern based on at least one of: the first cluster or the set of metadata.

In some embodiments, the processing circuitry is further configured to utilize the visualization agent to render the first recommended usage pattern. The visualization agent is configured to generate, based on at least one of: the first recommended usage pattern or the navigation pattern type, a visualization interface that presents the first recommended usage pattern associated with at least the first digital artifact. The visualization agent is further configured to render the visualization interface via the display device associated with the system.

In some embodiments, based on the navigation pattern type being a security navigation pattern type, the visualization agent is further configured to generate, based on the first recommended usage pattern, a heat map for at least the first digital artifact. The heat map is indicative of a risk severity metric associated with at least the first digital artifact. The visualization agent is further configured to render the heat map via the display device associated with the system.

In some embodiments, the processing circuitry is further configured to utilize the adaptive agent for generation of a query response to a user query. The adaptive agent is configured to access the user query associated with at least the first digital artifact. The adaptive agent is further configured to determine a context associated with the user query. The adaptive agent is further configured to generate, based on the context, a set of intermediate queries. The set of intermediate queries, collectively, corresponds to the context associated with the user query. The adaptive agent is further configured to communicate at least a subset of intermediate queries of the set of intermediate queries to at least one of: the navigator agent, the cluster agent, the visualization agent, or the function-specific agent. The adaptive agent is further configured to receive at least a first portion associated with a query response from at least one of: the navigator agent, the cluster agent, the visualization agent, or the function-specific agent. The adaptive agent is further configured to generate, in response to the user query, the query response based on at least the first portion associated with the query response. The visualization agent is configured to render the query response via the display device associated with the system.

In some embodiments, the storage element is further configured to store the set of digital artifacts by way of a dependency graph with each digital artifact of the set of digital artifacts forming a node of the dependency graph. An association between a first node of the dependency graph that represents at least the first digital artifact and a second node of the dependency graph that represents a second digital artifact of the set of digital artifacts is indicative of an association between at least the first digital artifact and the second digital artifact.

In some embodiments, the association between at least the first digital artifact and the second digital artifact corresponds to at least one of: a syntactic association or a semantic association.

In some embodiments, the processing circuitry is further configured to identify, based on the dependency graph, the second digital artifact associated with at least the first digital artifact. The first recommended usage pattern is determined further based on the second digital artifact.

In some embodiments, the first recommended usage pattern is associated with a function-specific score. The function-specific agent is configured to determine the function-specific score associated with the first recommended usage pattern. The function-specific agent is further configured to generate a set of feedback associated with the first recommended usage pattern based on the function-specific score. The visualization agent is configured to render the set of feedback via the display device associated with the system.

In some embodiments, the first digital pheromone trail is associated with a pheromone type which corresponds to a navigation pattern type that is indicated by the first cluster. The first cluster is generated further based on the pheromone type associated with the first digital pheromone trail.

In some embodiments, the processing circuitry is further configured to generate a second cluster for a second digital pheromone trail of the first set of digital pheromone trails based on the first usage score associated with the second digital pheromone trail exceeding the first threshold usage score. The second cluster includes at least the first digital artifact. The processing circuitry is further configured to determine, based on the second cluster, a second recommended usage pattern associated with at least the first digital artifact. The second recommended usage pattern is indicative of a second navigation pattern, of the first set of navigation patterns, represented by the second digital pheromone trail. The processing circuitry is further configured to render, via the display device associated with the system, the second recommended usage pattern.

In some embodiments, the processing circuitry is further configured to: determine a second plurality of operational attribute values for the plurality of operational attributes pertaining to each of a second plurality of operations associated with a third digital artifact of the set of digital artifacts. The processing circuitry is further configured to generate, based on the second plurality of operational attribute values, a second set of digital pheromone trails associated with the third digital artifact. The second set of digital pheromone trails represents a second set of navigation patterns associated with the third digital artifact. The processing circuitry is further configured to determine, based on the second plurality of operational attribute values, a second usage score associated with each digital pheromone trail of the second set of digital pheromone trails. The second usage score is indicative of traversal frequency of a navigation pattern associated with the digital pheromone trail. The processing circuitry is further configured to generate a third cluster for a third digital pheromone trail of the second set of digital pheromone trails based on the second usage score associated with the third digital pheromone trail exceeding a second threshold usage score. The third cluster includes the third digital artifact. The processing circuitry is further configured to determine, based on the third cluster, a third recommended usage pattern associated with the third digital artifact. The third recommended usage pattern is indicative of a third navigation pattern, of the second set of navigation patterns, represented by the third digital pheromone trail. The processing circuitry is further configured to render, via the display device associated with the system, the third recommended usage pattern.

In some embodiments, a method is disclosed. The method includes determining, by processing circuitry, a first plurality of operational attribute values for a plurality of operational attributes pertaining to each of a first plurality of operations associated with at least a first digital artifact of a set of digital artifacts stored in a storage element. The method further includes generating, by the processing circuity, based on the first plurality of operational attribute values for the plurality of operational attributes pertaining to each of the first plurality of operations, a first set of digital pheromone trails associated with at least the first digital artifact. The first set of digital pheromone trails represents a first set of navigation patterns associated with at least the first digital artifact. The method further includes determining, by the processing circuitry, based on the first plurality of operational attribute values, a first usage score associated with each digital pheromone trail of the first set of digital pheromone trails. The first usage score is indicative of traversal frequency of a navigation pattern associated with the digital pheromone trail. The method further includes generating, by the processing circuitry, a first cluster for a first digital pheromone trail of the first set of digital pheromone trails based on the first usage score associated with the first digital pheromone trail exceeding a first threshold usage score. The first cluster includes at least the first digital artifact. The method further includes determining, by the processing circuitry, based on the first cluster, a first recommended usage pattern associated with at least the first digital artifact. The first recommended usage pattern is indicative of a first navigation pattern of the first set of navigation patterns represented by the first digital pheromone trail. The method further includes rendering, by the processing circuitry, via a display device, the first recommended usage pattern.

In some embodiments, the determination of the first recommended usage pattern includes utilizing, by the processing circuitry, at least one of: a navigator agent, a cluster agent, a visualization agent, an adaptive agent, or a function-specific agent stored in the storage element.

In some embodiments, a computer-readable medium is disclosed. The computer-readable medium includes instructions that, when executed by processing circuitry of a computing system, cause the computing system to perform a method for facilitating usage pattern recommendation for digital artifacts. The method includes determining, by the processing circuitry, a first plurality of operational attribute values for a plurality of operational attributes pertaining to each of a first plurality of operations associated with at least a first digital artifact of a set of digital artifacts stored in a storage element. The method further includes generating, by the processing circuitry, based on the first plurality of operational attribute values for the plurality of operational attributes pertaining to each of the first plurality of operations, a first set of digital pheromone trails associated with at least the first digital artifact. The first set of digital pheromone trails represents a first set of navigation patterns associated with at least the first digital artifact. The method further includes determining, by the processing circuitry, based on the first plurality of operational attribute values, a first usage score associated with each digital pheromone trail of the first set of digital pheromone trails. The first usage score is indicative of traversal frequency of a navigation pattern associated with the digital pheromone trail. The method further includes generating, by the processing circuitry, a first cluster for a first digital pheromone trail of the first set of digital pheromone trails based on the first usage score associated with the first digital pheromone trail exceeding a first threshold usage score. The first cluster includes at least the first digital artifact. The method further include determining, by the processing circuitry, based on the first cluster, a first recommended usage pattern associated with at least the first digital artifact. The first recommended usage pattern is indicative of a first navigation pattern of the first set of navigation patterns represented by the first digital pheromone trail. The method further includes rendering, by the processing circuitry, via a display device, the first recommended usage pattern.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a schematic diagram that illustrates a system environment of a usage pattern recommendation system, consistent with embodiments of the present disclosure;

FIG. 2 is a schematic diagram that illustrates a process flow for an exemplary implementation of the usage pattern recommendation system, consistent with disclosed embodiments of the present disclosure;

FIG. 3 is a schematic diagram that illustrates a process flow for resolution of a query associated with the usage pattern recommendation system, consistent with disclosed embodiments of the present disclosure;

FIG. 4 illustrates a schematic diagram depicting an exemplary visualization interface rendering recommended usage patterns for a service orchestration product associated with the usage pattern recommendation system, consistent with disclosed embodiments of the present disclosure;

FIG. 5 shows an example computing system for carrying out the methods of the present disclosure, consistent with disclosed embodiments of the present disclosure; and

FIG. 6 is a flowchart that illustrates a method that facilitates usage pattern recommendation for digital artifacts, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Software products consist of numerous interconnected digital artifacts, such as source code, configuration files, design documents, user interfaces, databases, and APIs that collectively support their development and operation. These digital artifacts are accessed and manipulated by diverse stakeholders, including developers, testers, designers, project managers, and end-users, each performing specific tasks aligned with their roles within a software lifecycle.

During execution of these tasks, stakeholders frequently navigate across multiple digital artifacts or software components in sequential or iterative ways. These sequence of interactions may form navigation patterns, which represent the paths stakeholders follow to achieve particular goals. However, navigation patterns may often differ among individuals due to variations in experience, familiarity with the software products, access permissions, or personal working strategies. As a result, while some navigation patterns are efficient and goal-oriented, others may be suboptimal and less efficient, hence, may lead to redundant efforts, increased resource consumption, and reduced productivity.

Over time, experienced stakeholders tend to discover more efficient navigation patterns, yet these insights are seldom formalized or shared, making it difficult for less experienced stakeholders to replicate or benefit from these efficient navigation patterns. As software products become increasingly complex, the lack of mechanisms to identify and recommend optimal navigation patterns contributes to inefficiencies, skill disparities, and overall performance degradation. Therefore, it is important to identify, model, and recommend optimal navigation patterns that support stakeholders in performing their tasks effectively and consistently.

The present disclosure addresses the abovementioned limitations by providing a system (hereinafter, a usage pattern recommendation system) and a method that leverages concepts of artificial intelligence (AI) (for example, generative AI and agentic AI) to facilitate determination of usage pattern recommendations for the digital artifacts. The system disclosed herein includes a storage element configured to store a set of digital artifacts and a set of agents that may facilitate the determination of the usage pattern recommendations for the digital artifacts. The set of agents may include a navigator agent, a cluster agent, a function-specific agent, a visualization agent, or an adaptive agent. The storage element is further configured to store a logic store based on which the usage pattern recommendations are determined by the set of agents.

Each digital artifact of the set of digital artifacts may correspond to a module of a software product. A digital artifact of the set of digital artifacts may interact with one or more digital artifacts of the set of digital artifacts for the implementation of a set of tasks associated with the software product. The software product may be a legacy software product or a modernized software product. For the sake of brevity, the software product is assumed to be a legacy software product.

A plurality of operations associated with a first digital artifact of the set of digital artifacts may be performed by way of display devices associated with one or more stakeholders. The plurality of operations may encompass all the interactions, actions, and analyses that the one or more stakeholders may perform when working with the first digital artifact in different operational contexts. For example, the plurality of operations may include static code analysis operations, code modification operations, testing and validation operations, deployment and integration operations, monitoring and mentoring operations, security operations, quality assurance operations, or the like.

Each operation associated with the first digital artifact may be associated with a plurality of operational attributes. The plurality of operational attributes may include at least two of a functional attribute, a non-functional attribute, or a hidden attribute. The functional attributes may define specific behaviors, functions, and features that the first digital artifact may support. Non-functional attributes may relate to quality characteristics such as performance, security, maintainability, and reliability of the first digital artifact. Hidden attributes may capture implicit data from user interactions and usage patterns associated with the first digital artifact.

The plurality of operations may be performed by way of the display devices associated with the one or more stakeholders by interacting with the first digital artifact. The interaction of a stakeholder during the execution of an operation associated with the first digital artifact may correspond to, or be regarded as, a navigation pattern that reflects how the stakeholder engages with and transitions between digital artifacts of the set of digital artifacts to accomplish a specific task or goal.

Navigation patterns represent systematic sequences of user interactions with a user interface of the software product, encompassing both direct manipulation of the digital artifact and indirect navigation behaviors. The navigation pattern captures user interface interactions such as cursor movement trajectories, input field navigation sequences, menu selection patterns, file access orders, and component interaction workflows that collectively define how stakeholders traverse through each digital artifact of the set of digital artifacts to accomplish specific operational objectives.

The system disclosed herein further includes processing circuitry that may utilize the set of agents for the determination of the usage pattern recommendations. In operation, the processing circuitry may utilize the navigator agent to determine a plurality of operational attribute values for the plurality of operational attributes pertaining to the plurality of operations associated with the first digital artifact of the set of digital artifacts. The plurality of attribute values may be indicative of operational metadata associated with the plurality of operations. The operational metadata may represent structured information that describes the circumstances, characteristics, and operational context associated with each operation.

The processing circuitry may be further configured to utilize the navigator agent to generate, based on the first plurality of operational attribute values, a first set of digital pheromone trails associated with the first digital artifact. A digital pheromone trail may correspond to a computational representation of navigation sequences through the set of digital artifacts. In other words, a digital pheromone trail may be indicative of a sequence of access to one or more digital artifacts of the set of digital artifacts. That is to say, each navigation pattern may be represented by a corresponding digital pheromone trail.

The processing circuitry may be further configured to utilize the navigator agent to store the first plurality of operational attribute values in the storage element. The processing circuitry may be further configured to utilize the cluster agent to acquire the first plurality of operational attribute values for the plurality of operational attributes from the storage element. The processing circuitry may be further configured to utilize the cluster agent to determine, based on the first plurality of operational attribute values, a first usage score associated with each digital pheromone trail of the first set of digital pheromone trails. The usage score may refer to a numerical metric that quantifies a traversal frequency of a navigation pattern associated with a digital pheromone trail (for example, the first digital pheromone trail). The processing circuitry may be further configured to utilize the cluster agent to generate a first cluster for a first digital pheromone trail of the first set of digital pheromone trails. The first cluster may be generated based on the first usage score associated with the first digital pheromone trail exceeding a first threshold usage score.

The processing circuitry 104 may further utilize a function-specific agent for determination of a first recommended usage pattern associated with the first digital artifact. The function-specific agent may determine, based on the first cluster, the first recommended usage pattern associated with the first digital artifact. The first recommended usage pattern may be indicative of a first navigation pattern, of the first set of navigation patterns, represented by the first digital pheromone trail. The first recommended usage pattern may refer to a suggested sequence or arrangement of interactions with one or more digital artifacts of the first set of digital artifacts. The first recommended usage pattern may represent an optimized or frequently observed usage sequence of the one or more digital artifacts of the first set of digital artifacts, which may facilitate the stakeholders in efficiently navigating and utilizing the software product.

The processing circuitry may be further configured to utilize the visualization agent to generate, based on the first recommended usage pattern, a visualization interface that presents the first recommended usage pattern associated with the first digital artifact. The visualization agent may be further configured to render the visualization interface via a display device associated with the system. In some embodiments, the processing circuitry may utilize the adaptive agent for generation of a query response to a query associated with the software product.

The disclosed system offers significant advantages, including automated adjustments of usage pattern recommendations based on actual usage patterns, ensuring that highly utilized and effective usage pattern recommendations remain prominent while obsolete patterns fade away. The continuous updating mechanism may ensure that recommended usage patterns reflect current system behavior rather than historical data, making usage pattern recommendations more relevant to present conditions and user needs. The system becomes sensitive to changes in development practices, user behavior, or system architecture, automatically adapting the usage pattern recommendations as the software product evolves over time.

The system generates personalized, context-aware recommendations that consider user roles, expertise levels, current operational objectives, and specific system conditions. This targeted guidance significantly reduces cognitive load on stakeholders, such as developers and analysts, while improving the effectiveness of diagnostic and optimization activities. By automatically capturing and encoding successful navigation patterns as digital pheromone trails, the system facilitates seamless knowledge transfer between team members and preserves institutional knowledge that would otherwise be lost due to personnel changes or project transitions.

The distributed agent-based architecture enables the system to scale efficiently across large, complex software ecosystems, simultaneously analyzing multiple digital artifacts and providing specialized guidance for different functional domains without performance degradation or resource conflicts. Through intelligent clustering of related digital artifacts and provision of optimized usage recommendation patterns, the system significantly reduces the time required to identify root causes of functional discrepancies, implement effective solutions, and validate remediation efforts.

By continuously monitoring operational attribute trends and pattern evolution, the system can identify potential issues before they manifest as functional discrepancies, enabling proactive maintenance and preventing system degradation. The system provides dynamic, context-aware visualizations that adapt to user needs, operational contexts, and system conditions, presenting information in the most effective format for the current situation and user objectives.

### Figure Description

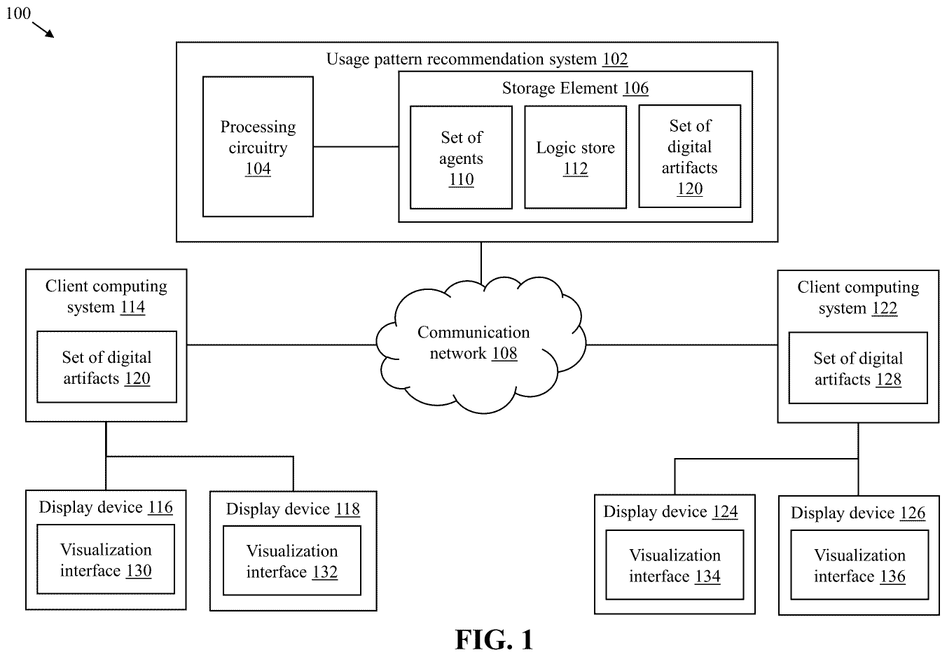

FIG. 1 is a schematic diagram that illustrates a system environment 100 of a usage pattern recommendation system 102, consistent with embodiments of the present disclosure. The usage pattern recommendation system 102 provides usage recommendation patterns for a set of digital artifacts to entities associated with a software product. The term ‘usage pattern recommendation system 102’ is interchangeably referred to as the ‘system 102’.

Referring to FIG. 1, the system environment 100 is shown to include the usage pattern recommendation system 102 having processing circuitry 104 and a storage element 106 communicatively coupled to the processing circuitry 104. In an embodiment, the processing circuitry 104 and the storage element 106 may be coupled via a communication bus (not shown).

In some embodiments, the usage pattern recommendation system 102 may correspond to a distributed system. In such embodiments, the processing circuitry 104 and the storage element 106 may be implemented in a distributed environment. In some embodiments, the storage element 106 may be implemented as a cloud-based storage.

In some embodiments, the processing circuitry 104 and the storage element 106 may be communicably coupled via a communication network 108. The communication network 108 may act as a medium or communication channel between two or more components of the system environment 100. Examples of the communication network 108 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, or a combination thereof.

The processing circuitry 104 may include suitable logic, circuitry, interfaces, and/or code, that when executed, may execute one or more operations associated with an artificial intelligence (AI)-based usage pattern recommendation for the set of digital artifacts (for example, a set of code modules associated with a software product, where the software product may correspond to a legacy software product or a modern software product). The processing circuitry 104 may be implemented by one or more processors, such as, but not limited to, an application-specific integrated circuit (ASIC) processor, a reduced instruction set computer (RISC) processor, a complex instruction set computer (CISC) processor, and a field programmable gate array (FPGA) processor. The one or more processors may also correspond to central processing units (CPUs), graphics processing units (GPUs), neural processing units (NPUs), digital signal processors (DSPs), or the like. It will be apparent to a person skilled in the art that the processing circuitry 104 may be compatible with multiple operating systems. The processing circuitry 104 may further include one or more components (for example, a parser, a loader, or the like) that may be configured to execute one or more operations to be executed by the processing circuitry 104. In some embodiments, the processing circuitry 104 may be a single unit. Alternatively, in some embodiments, the processing circuitry 104 may be a combination of various modules configured to execute the one or more operations associated with the AI-based usage pattern recommendation for the set of digital artifacts.

The storage element 106 may refer to a hardware or software component configured to store, but not limited to, a set of agents 110 and a logic store 112. The set of agents 110 and the logic store 112 in the storage element 106 may be accessed by the processing circuitry 104 for recommending the usage pattern for the set of digital artifacts. The storage element 106 may include a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.), or any combination thereof. The storage element 106 may be locally or remotely associated with the processing circuitry 104.

The set of agents 110 may correspond to one or more AI agents (for example, generative AI agents or agentic AI agents) that may be configured to execute one or more operations associated with the AI-based recommendation of usage patterns for the set of digital artifacts. The set of agents 110 may be utilized by the processing circuitry 104 for the execution of the one or more operations associated with the recommendation of usage patterns for the set of digital artifacts.

The set of agents 110 may include, but is not limited to, a navigator agent, a cluster agent, a function-specific agent, a visualization agent, or an adaptive agent. The set of agents 110 may execute the one or more operations associated with usage pattern recommendation for the digital artifacts (namely, the set of digital artifacts) sequentially or in parallel. In some embodiments, the set of agents 110 may execute the one or more operations collectively to determine and visualize usage pattern recommendation for the set of digital artifacts to entities associated with the software product.

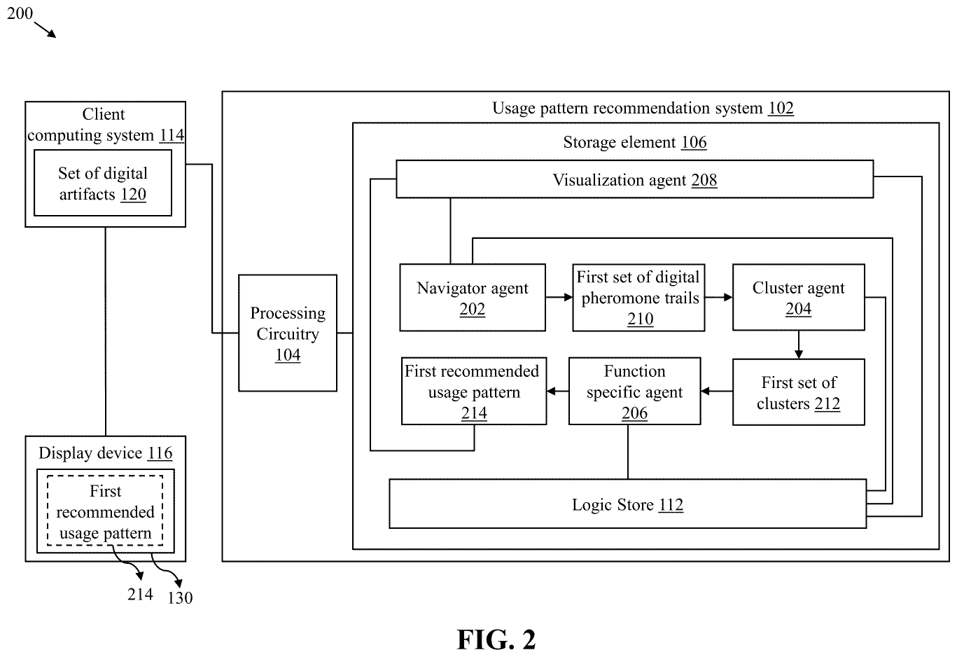

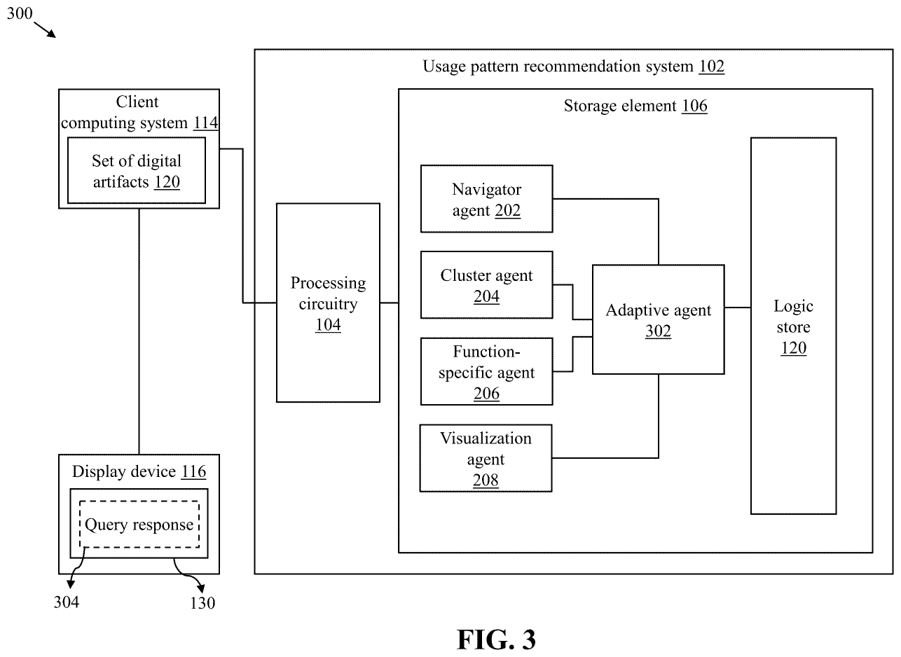

The processing circuitry 104 may further act as an orchestrator for the set of agents 110. For example, the processing circuitry 104 may be further configured to coordinate a sequence of operations executed by the set of agents 110. Each agent of the set of agents 110 may be configured to perform specific functions that, collectively, enable recommendation of usage pattern for the digital artifacts associated with the software product. For the sake of brevity, the set of agents 110 is illustrated and described in detail in conjunction with FIGS. 2 and 3.

The logic store 112 may include computational elements such as rules, policies, constraints, heuristics, or machine-learned models that govern a way in which the recommendation of usage pattern for the digital artifacts associated with the software product is performed. The logic store 112 further comprises a set of logic constraints that includes entity-specific and digital artifacts specific subsets of logic constraints pertaining to the determination of usage pattern recommendations based on operational context associated with each digital artifact of the set of digital artifacts. The set of logic constraints define operational parameters, functional boundaries, prioritization criteria, and computational rules that control how the processing circuitry 104 or the set of agents 110 evaluates usage of each of the set of digital artifacts, determines a recommendation of usage pattern for the set of digital artifacts and subsequently, ranks, and renders the recommended usage pattern for the set of digital artifacts. In some embodiments, the computational elements may be static, such as predefined rules or regulations.

The usage pattern recommendation system 102 may be coupled to a computing system that implements the software product or the set of digital artifacts. Each of the plurality of entities associated with the set of digital artifacts may be further associated with the computing system via a corresponding display device. Further, each entity of the plurality of entities may visualize a usage pattern recommendation by way of the corresponding display device. Examples of a display device may include, but are not limited to, a laptop, a phone, a tablet, a phablet, or the like. The plurality of entities corresponds to various stakeholders associated with the set of digital artifacts. Examples of an entity may be an end user, a developer, a security analyst, a quality analyst, a project manager, or the like.

As shown, the usage pattern recommendation system 102 is associated with a client computing system 114 via the communication network 108. The client computing system 114 is shown to be associated with display devices 116 and 118 that may be associated with first and second entities, respectively, associated with the client computing system 114. The client computing system 114 is shown to be associated with a set of digital artifacts 120 associated with a first software product. The first and second entities may access the set of digital artifacts 120 via the display devices 116 and 118, respectively. Notably, the first and second entities may be associated with the first software product with the same or different capacities, roles, and access permissions. Hence, the first and second entities may require to visualize and implement the same or different usage recommendation pattern for execution of one or more operations associated with the set of digital artifacts 120.

In some embodiments, the set of digital artifacts 120 may be stored in the storage element 106. In another embodiment, the set of digital artifacts 120 may be hosted on the client computing system 114, and accessed by the usage pattern recommendation system 102 via the communication network 108.

As shown, the usage pattern recommendation system 102 is further associated with a client computing system 122 via the communication network 108. The client computing system 122 is shown to be associated with display devices 124 and 126 that may be associated with third and fourth entities, respectively, associated with the client computing system 122. The client computing system 122 is shown to be associated with a set of digital artifacts 128 associated with a second software product. The third and fourth entities may access the set of digital artifacts 128 via the display devices 124 and 126, respectively. Notably, the third and fourth entities may be associated with the second software product with same or different capacities, roles, and access permissions. Hence, the third and fourth entities may require to visualize and implement same or different usage recommendation pattern for execution of one or more operations associated with the set of digital artifacts 128. Similarly, the usage pattern recommendation system 102 may be coupled to one or more other client computing systems (not shown) via the communication network 108. For the sake of brevity, the ongoing description is described with respect to the set of digital artifacts 120. It will be apparent to a person skilled in the art that usage pattern recommendation for the set of digital artifacts 128 or any other set of digital artifacts may be performed in a similar manner.

The first entity may visualize a corresponding relevant usage pattern recommendation for the set of digital artifacts 120 by way of a visualization interface 130 of the display device 116. Similarly, the second entity may visualize a corresponding relevant usage pattern recommendation for the set of digital artifacts 120 by way of a visualization interface 132 of the display device 118. The display devices 116 and 118 may host a user application, which may be an executable module of the usage pattern recommendation system 102 (namely, the system 102). The visualization interfaces 130 and 132 may present the user application to the first and second entities via the display devices 116 and 118, respectively. The user application may be used by the first and second entities to visualize a corresponding relevant usage pattern recommendation for the set of digital artifacts 120.

In an embodiment, the system 102 may communicate with the display device 116 to present the relevant usage pattern recommendation for the set of digital artifacts 120 to the first entity via the visualization interface 130. The system 102 may execute one or more operations for determination of the usage pattern recommendation for the set of digital artifacts 120 that may be relevant to the first entity. In another embodiment, the system 102 may communicate with the display device 118 to present the relevant usage pattern recommendation for the set of digital artifacts 120 to the second entity via the visualization interface 132. The system 102 may execute one or more operations for determination of the usage pattern recommendation for the set of digital artifacts 120 that may be relevant to the second entity. In yet another embodiment, the system 102 may communicate with the display devices 116 and 118 to present the relevant usage pattern recommendation for the set of digital artifacts 120 to the first and second entities via the visualization interfaces 130 and 132, respectively. The system 102 may execute one or more operations for determination of the usage pattern recommendation for the set of digital artifacts 120 that may be relevant to the first and second entities.

A first plurality of operations associated with at least a first digital artifact of the set of digital artifacts may be performed by way of display devices 116 and 118 associated with the first and second entities, respectively. The first plurality of operations may encompass all the interactions, actions, and analyses that the one or more stakeholders may perform, via the corresponding display devices, when working with at least the first digital artifact in different operational contexts. For example, the first plurality of operations may include static code analysis operations, code modification operations, testing and validation operations, deployment and integration operations, monitoring and mentoring operations, security operations, or the like.

Each operation associated with at least the first digital artifact may be associated with a plurality of operational attributes. The plurality of operational attributes may include at least two of a functional attribute associated with at least the first digital artifact, a non-functional attribute associated with at least the first digital artifact, or a hidden attribute associated with at least the first digital artifact.

The functional attributes may be indicative of functions associated with at least the first digital artifact. For instance, the functional attributes may define specific behaviour, functions, and features that at least the first digital artifact may support. The functional attributes may include call hierarchies. The call hierarchies may include details about function calls and dependencies associated with at least the first digital artifact. The plurality of functional attributes may further include dependency information. For example, the dependency information may correspond to information about external libraries and test coverage associated with at least the first digital artifact. The functional attributes may be directly related to the actions and operations associated with at least the first digital artifact. Examples of the functional attributes may include, but are not limited to, user authentication, data processing, reporting, payment processing, function signatures, method definitions, parameter specifications, return types, class hierarchies, interface contracts, service calls, API endpoints, database queries, business logic implementation, workflow orchestration, and data validation routines.

The non-functional attributes associated with at least the first digital artifact may be indicative of overall performance and user experience of a client computing system 114. The non-functional attributes may include static analysis metrics. The static analysis metrics may include code complexity measures like cyclomatic complexity. The non-functional attributes may further include code smells and anti-patterns, for example, identified potential issues associated with the digital artifact. The non-functional attributes may further include performance hotspots, security vulnerabilities, deprecated application programming interface (API) usage, scalability characteristics, usability metrics, reliability measures, or the like. Examples of the non-functional attributes may include, but are not limited to, response time measurements, memory usage patterns, CPU utilization metrics, throughput capacity, error rates, availability percentages, maintainability indices, code duplication levels, technical debt assessments, compliance violations, accessibility standards adherence, and load balancing efficiency.

The hidden attributes associated with at least the first digital artifact may refer to data captured from the interaction of one or more entities, for example, a developer with at least the first digital artifact. For example, the developer interactions may include edits performed on at least the first digital artifact, navigation patterns of the developer, co-edit frequencies associated with at least the first digital artifact, or the like. The hidden attributes may be recorded implicitly. For example, how the developers may actually work with at least the first digital artifact, rather than relying on direct user input or formal updates to documentation (for example, version control histories or code analysis reports) associated with at least the first digital artifact. Therefore, the hidden attributes may be regarded as hidden, as the hidden attributes may reflect an inherent context of day-to-day interaction of the developer with the digital artifact. Further, the hidden attributes may include version control metadata, such as commit history, authorship, modification dates of the digital artifact, modification timestamp of the digital artifact, or the like. Examples of the hidden attributes may include, but are not limited to, edit frequency patterns, time spent reviewing code sections, debugging session durations, code search queries, file access sequences, collaboration patterns between developers, review comment frequencies, merge conflict resolution patterns, testing behaviour analytics, and implicit developer preferences derived from usage patterns.

The plurality of operations may be performed by way of the display devices 116 and 118 associated with the first and second entities, respectively, by interacting with the set of digital artifacts 120. The interaction of the first and second entities during the execution of the plurality of operations associated with at least the first digital artifact may correspond to, or be regarded as, a navigation pattern that reflects how the first and second entities engage with and transitions between digital artifacts of the set of digital artifacts 120 to accomplish a specific task or goal. Navigation patterns may represent systematic sequences of user interactions with the first software product interface, encompassing both direct manipulation of the set of digital artifacts 120 and indirect navigation behaviors. The navigation pattern may capture user interface interactions such as cursor movement trajectories, input field navigation sequences, menu selection patterns, file access orders, and component interaction workflows that, collectively, define how stakeholders traverse through each digital artifact of the set of the digital artifacts 120 to accomplish specific operational objectives. Further, each navigation pattern may be associated with a navigation pattern type.

A navigation pattern type may correspond to a functional context of a navigation workflow associated with the use of each digital artifact of the set of digital artifacts 120. Example of navigation pattern type may include a security navigation pattern type, a performance navigation pattern type, a refactoring navigation pattern type, or the like. The security navigation pattern type may be associated with a navigation workflow that is optimized for security related operations, analysis, and assessment activities, characterized by sequences designed to identify, analyze, and address security vulnerabilities, compliance requirements, and risk factors. Similarly, the performance navigation pattern type may be associated with a navigation workflow that is optimized for performance analysis, optimization, and monitoring activities, characterized by sequences and methodologies designed to identify bottlenecks, improve system efficiency, and enhance scalability. Similarly, the refactoring navigation pattern type may be associated with a navigation workflow that is optimized for code restructuring, quality improvement, and maintainability enhancement activities, characterized by sequences designed to reduce complexity, improve code design and structure, or the like.

As described above, the plurality of operations encompasses all the interactions, actions, and analyses performed by way of the display devices 116 and 118 associated with the first and second entities when working with the set of digital artifacts 120 across various operational contexts, each of which drives different types of navigation behaviors. For example, in security operational contexts, vulnerability assessments, compliance audits, penetration testing, and risk evaluations, which may lead to security-focused navigation patterns are performed by way of the display devices 116 and 118 associated with the first and second entities, where the first and second entities systematically examine authentication services, validation components, encryption modules, audit systems, or the like. Similarly, performance operational contexts may involve bottleneck identification, optimization analysis, scalability assessment, and resource monitoring, resulting in performance-oriented navigation patterns that guide users through database connections, caching layers, monitoring systems, resource managers, or the like. Similarly, code refactoring operational contexts encompass complexity reduction, design pattern implementation, technical debt elimination, and maintainability improvement, creating refactoring-focused navigation patterns that direct users through complex methods, duplicated code segments, architectural components, and design structures. For the sake of brevity of the description, the plurality of operations is assumed to be performed only by way of display devices associated with the first and second entities. In actual implementations of the system 102, the plurality of operations may be performed by way of any number of user devices associated with any number of entities.

In operation, the processing circuitry 104 may utilize the navigator agent to determine the plurality of operational attributes pertaining to each of a first plurality of operations associated with at least the first digital artifact of the set of digital artifacts 120. In an embodiment, the first plurality of operations associated with at least the first digital artifact may correspond to the security and vulnerability assessment operational context. In such an embodiment, operations such as vulnerability scanning, compliance verification, penetration testing, security code review, or risk evaluation activities may be performed via display devices 116 and 118 associated with the first and second entities, respectively. In another embodiment, the first plurality of operations associated with at least the first digital artifact may correspond to the code refactoring operational context. In such an embodiment, operations such as complexity reduction analysis, design pattern implementation, technical debt assessment, code restructuring, or maintainability improvement activities may be performed via display devices 116 and 118 associated with the first and second entities, respectively. In yet another embodiment, the first plurality of operations associated with at least the first digital artifact may correspond to the performance optimization operational context. In such an embodiment, operations such as bottleneck identification, resource utilization analysis, scalability assessment, performance monitoring, or system efficiency evaluation activities may be performed via display devices 116 and 118 associated with the first and second entities, respectively.

The navigator agent may be further configured to determine operational metadata corresponding to the first plurality of operations associated with at least the first digital artifact. The operational metadata may correspond to structured contextual information that characterizes the circumstances, parameters, and environmental conditions based on which each operation of the first plurality of operations is executed on the set of digital artifacts 120. The operational metadata may include details such as the identity and role of the first and second entities associated with the display devices 116 and 118, respectively, by way of which the first plurality of operations are being performed, a specific task, process, or modification being carried out on the set of digital artifacts 120, a timestamp or temporal sequence of execution of the first plurality of operations, an objective of the execution of the first plurality of operations, an operational context associated with the first plurality of operations, or the like. Collectively, the operational metadata may provide a comprehensive contextual understanding of each operation of the first plurality of operations being performed on the set of digital artifacts 120. Further, the navigator agent may be configured to determine a first plurality of operational attribute values for the plurality of operational attributes based on the operational metadata. That is to say, the navigator agent is configured to determine the first plurality of operational attribute values for the plurality of operational attributes pertaining to each of the first plurality of operations associated with at least the first digital artifact of the set of digital artifacts 120.

The navigator agent may be further configured to generate, based on at least one of the first plurality of operational attribute values for the plurality of operational attributes pertaining to each of the first plurality of operations and the operational metadata, a first set of digital pheromone trails associated with at least the first digital artifact. A digital pheromone trail may correspond to a computational representation of navigation sequences through the digital artifacts (namely, the set of digital artifacts 120). In other words, a digital pheromone trail may be indicative of a sequence of access of one or more digital artifacts of the set of digital artifacts 120. That is to say, each navigation pattern may be represented by a corresponding digital pheromone trail. Thus, the first set of digital pheromone trails may represent a first set of navigation patterns associated with at least the first digital artifact. The first set of digital pheromone trails may correspond to a collection of computational markers that may collectively represent multiple navigation patterns associated with at least the first digital artifact. Each digital pheromone trail may function as an indicator of a sequential access pattern of one or more digital artifacts of the set of digital artifacts 120 that were traversed by way of the display devices 116 and 118 associated with the first and second entities, respectively, when interacting with the one or more digital artifacts of the set of digital artifacts 120.

Notably, each digital pheromone trail may be associated with a pheromone type such that the pheromone type of a digital pheromone trail may directly correspond to the navigation pattern type of the navigation pattern being represented by the digital pheromone trail. For example, a digital pheromone trail having a security and vulnerability pheromone type may represent a security vulnerability navigation pattern type, indicating that the captured navigation sequence is determined based on security focused operations.

The navigator agent may be further configured to store the first plurality of operational attribute values in the storage element 106. In an embodiment, the cluster agent may be associated with a cluster type. A cluster type may correspond to a functional context associated with a clustering operation. Example of cluster type may include security cluster type, performance cluster type, refactoring cluster type, or the like.

Notably, the pheromone type (such as performance pheromone type, security vulnerability pheromone type, refactoring pheromone type, or the like) may provide contextual guidance for the clustering process. The cluster agent having the security cluster type may indicate that the cluster agent may cluster one or more digital artifacts based on the digital pheromone trail having a security and vulnerability pheromone type. Similarly, a cluster agent having the performance cluster type may indicate that the cluster agent may cluster one or more digital artifacts based on the digital pheromone trail having a performance pheromone type. Similarly, a cluster agent having the refactoring cluster type may indicate that the cluster agent may cluster one or more digital artifacts based on the digital pheromone trail having a refactoring pheromone type. The cluster agent may be configured to access the storage element 106. Further, the cluster agent may be configured to match the cluster type with the navigation pattern type associated with each of the first set of navigation patterns. Based on a match of the cluster type with the navigation pattern type, the cluster agent may acquire the first plurality of operational attribute values for the plurality of operational attributes. For example, a match between the performance cluster type and performance navigation pattern may indicate that the cluster agent may acquire the first plurality of operational attribute values determined by the navigator agent for performance related operations.

The cluster agent may be further configured to determine, based on the first plurality of operational attribute values, a first usage score associated with each digital pheromone trail of the first set of digital pheromone trails. As used herein, the term usage score may refer to a numerical metric that quantifies a traversal frequency of a navigation pattern associated with a digital pheromone trail (for example, the first digital pheromone trail). That is to say, the first usage score may be indicative of traversal frequency of a navigation pattern associated with the digital pheromone trail. The first usage score may be calculated based on a number of times a particular navigation pattern has been accessed, executed, or referenced within a specified time period. Notably, the usage score may be indicative of an importance of a specific navigation pattern. A higher usage score may indicate more frequently traversed paths through the set of digital artifacts 120. For example, a usage score may be computed by counting the number of developer interactions, code executions, or the like that may follow a particular navigation sequence, providing insight into which navigation paths are most commonly utilized within the software product.

The cluster agent may be further configured to generate a first cluster for a first digital pheromone trail of the first set of digital pheromone trails based on the first usage score associated with the first digital pheromone trail exceeding a first threshold usage score. The generation of the first cluster based on the first usage score exceeding the first threshold usage score may indicate that the first digital pheromone trail represents a sufficiently relevant navigation pattern associated with the first set of digital artifacts 120. Notably, the cluster agent may be configured to generate a first set of clusters for the first set of digital pheromone trails based on a usage score associated with each digital pheromone trail of the first set of digital pheromone trails exceeding a corresponding threshold usage score.

Notably, the threshold usage score for each pheromone type associated with a digital pheromone trail may be different and dynamic in nature. The threshold usage scores may depend on various factors such as importance, usability, criticality, or other domain-specific considerations associated with each pheromone type. For example, a threshold usage score for a digital pheromone trail with the security and vulnerability pheromone type may be lower, due to the significant importance of identifying security vulnerabilities associated with at least the first digital artifact, even with minimal traversal frequency.

As described above, the first cluster is generated further based on the pheromone type associated with the first digital pheromone trail, ensuring that the cluster agent clusters together the digital artifacts that share similar characteristics as defined by the pheromone type of the first digital pheromone trail. The first cluster may contain all the digital artifacts of the set of digital artifacts 120 that are associated with the first digital pheromone trail and exhibit contextual alignment with the specified pheromone type. Notably, the first cluster includes at least the first digital artifact. That is to say, every digital artifact connected by or participating in the first navigation pattern represented by the first digital pheromone trail may be included in the first cluster.

The processing circuitry 104 may utilize a function-specific agent for determination of a first recommended usage pattern associated with at least the first digital artifact. The function-specific agent may have a function-specific type associated therewith. The function-specific type may be indicative of a task or operation associated with the first software product that is performed by the function-specific agent. Based on the task or operation performed by the function-specific agent, the function-specific agent may be one of a performance agent, a security agent, a refactoring agent, or the like. The function-specific agent may determine, based on the first cluster, the first recommended usage pattern associated with at least the first digital artifact. Notably, the first recommended usage pattern is indicative of a first navigation pattern, of the first set of navigation patterns, represented by the first digital pheromone trail. In an embodiment, for the determination of the first recommended usage pattern, the function-specific agent may be configured to receive, from the cluster agent, at least one of the first cluster and a set of metadata associated with the first cluster. The function-specific agent may receive the first cluster from the cluster agent that has a cluster type that matches the function-specific type of the function-specific agent. The set of metadata associated with the first cluster may correspond to a structured collection of descriptive information that characterizes the operational context, functional domain, or navigational characteristics of the one or more digital artifacts clustered within the first cluster (for example, the first navigation pattern). The function-specific agent may be further configured to determine the first recommended usage pattern based on at least one of the first cluster and the set of metadata.

The first recommended usage pattern may refer to a suggested sequence or arrangement of interactions with respect to one or more digital artifacts of the set of digital artifacts 120 that may be followed/adopted/adhered to follow a task or operation associated with the function-specific agent. The first recommended usage pattern may be determined by the function-specific agent, based on analysis of navigation behaviors of the first and second entities with the first software product. The first recommended usage pattern may represent an optimized or frequently observed usage sequence of the one or more digital artifacts of the set of digital artifacts 120, that can guide the stakeholders (namely, the first and second entities) in efficiently navigating and utilizing the software product. The determination of the first recommended usage pattern based on the first cluster may involve analyzing the digital artifacts grouped within the first cluster and identifying the most effective or commonly used navigation sequence among them.

The processing circuitry 104 may utilize the function-specific agent to analyze the first cluster and extract the underlying navigation pattern that connects the clustered one or more digital artifacts of the set of digital artifacts 120. The first navigation pattern, represented by the first digital pheromone trail, may become a basis for the determination of the first recommended usage pattern. For example, if the first cluster contains a first digital artifact corresponding to a user authentication module, a second digital artifact corresponding to a payment processing module, and a third digital artifact corresponding to an order confirmation module, and these digital artifacts are connected by the first digital pheromone trail indicating frequent sequential access with security vulnerabilities, the first recommended usage pattern may identify specific code sections within these digital artifacts that may require security focus. For example, the first software product containing millions of lines of code, the first navigation pattern may reveal that the stakeholders (namely, the first and second entities functioning as developers) frequently access only a password validation functions (approximately 2,000 lines) within the user authentication digital artifact, the credit card tokenization routines (approximately 1,500 lines) within the payment processing digital artifact, and the transaction logging functions (approximately 800 lines) within the order confirmation digital artifact.

In such a scenario, the first recommended usage pattern may suggest implementing enhanced security measures specifically for these frequently accessed code sections, such as additional input sanitization for the password validation functions, stronger encryption protocols for the credit card tokenization routines, and secure audit trails for the transaction logging functions, rather than applying security measures to the entire digital artifacts.

The first recommended usage pattern may include information such as the secure and efficient sequence for accessing specific code sections within each digital artifact of the one or more digital artifacts with targeted security checkpoints, required security validations for particular functions during navigation steps, expected security outcomes or risk mitigation benefits of following the first navigation pattern, and alternative secure pathways when specific code sections within the one or more digital artifacts may exhibit high security risks. The first recommended usage pattern may be indicative of guidance for developers who may need to focus on the most critical and frequently accessed code sections, security teams who may prioritize remediation efforts based on actual usage patterns, or the like.

The processing circuitry 104 may be further configured to detect a traversal operation associated with the first recommended usage pattern. For example, the processing circuitry 104 may monitor and detect when the stakeholders (namely, the first and second entities) are actually traversing through the first recommended usage pattern. The processing circuitry 104 may be further configured to increment, based on the detection of the traversal operation, the first usage score associated with the first digital pheromone trail in accordance with an activation function. The activation function may apply various mathematical models such as linear increments, logarithmic scaling, or weighted increases based on factors like user type, traversal success, or contextual importance. For example, if a developer (for example, the first entity) successfully follows the first recommended usage pattern through the user authentication digital artifact, payment processing digital artifact, and order management digital artifact, the processing circuitry 104 may increment the first usage score by a value determined by the activation function.

The processing circuitry 104 may be further configured to continuously decrement the first usage score in accordance with an evaporation function associated with the first recommended usage pattern. The evaporation function may employ exponential decay, linear decrement, or temporal degradation models to progressively reduce the influence of obsolete or inactive instances of navigation patterns on the generation of recommended usage patterns (for example, the first recommended usage pattern). Notably, the activation function and evaporation function may be specific to a pheromone type of the first digital pheromone trail or a function-specific type associated with the function-specific agent.

The processing circuitry 104 may be further configured to utilize the visualization agent to generate, based on the first recommended usage pattern, the visualization interface 130 that presents the first recommended usage pattern associated with at least the first digital artifact. The visualization agent may be further configured to render the visualization interface 130 via the display device 116 associated with the system 102. In some embodiments, the first recommended usage pattern may be rendered over the visualization interface 130, via the display device 116, to the first entity and the visualization interface 132, via the display device 118, to the second entity.

In an embodiment, the processing circuitry 104 may be further configured to create a dependency graph for the set of digital artifacts 120. In an embodiment, the processing circuitry 104 may create the dependency graph based on the rules and associations described in the logic store 112. The processing circuitry 104 may create a node for each digital artifact of the set of digital artifacts 120. That is to say, the processing circuitry 104 may create the dependency graph with each digital artifact of the set of digital artifacts 120 forming a node of the dependency graph. In such an embodiment, the storage element 106 may be further configured to store the set of digital artifacts 120 by way of the dependency graph. Further, each digital artifact of the set of digital artifacts 120 may be associated with each other. That is to say, an association between a first node of the dependency graph that represents at least the first digital artifact and a second node of the dependency graph that represents a second digital artifact of the set of digital artifacts 120 may be indicative of an association between at least the first digital artifact and the second digital artifact. The association between at least the first digital artifact and the second digital artifact may correspond to at least one of a syntactic association and a semantic association.

For example, in case of the syntactic association, the first node may be associated with the second node based on an encoded linkage between at least the first digital artifact and the second digital artifact. In another example, the first node may be associated with the second node based on the first digital artifact importing the second digital artifact via an import statement. In another example, the first node may be associated with the second node based on a class of the first digital artifact implementing or extending an interface from the second digital artifact. In another example, the first node may be associated with the second node based on the second digital artifact being organized hierarchically within the first software product. In yet another example, the first node may be associated with the second node based on the first digital artifact invoking a function or method defined in the second digital artifact.

In case of the semantic association, the first node may be associated with the second node based on the functional dependencies or operational behaviour of the first digital artifact and the second digital artifact. For example, the first digital artifact and the second digital artifact may both interact with a common database associated with the client computing system 114. Notably, any change in the structure, schema, or behaviour of the database may directly impact the first digital artifact and the second digital artifact, as the correctness and functionality of the first digital artifact and the second digital artifact may be dependent on the shared data. That is to say, even if the first digital artifact and the second digital artifact are not syntactically associated with each other, the semantic association may capture dependencies between the first digital artifact and the second digital artifact.

Although the examples are explained in terms of the first digital artifact or the second digital artifact, the scope of the present disclosure is not limited to it. The syntactic or semantic associations may exist between any number of digital artifacts included within the first software product. That is to say, each digital artifact may be syntactically or semantically connected to one or more digital artifacts of the set of digital artifacts 120. In an embodiment, the processing circuitry 104 may be further configured to traverse the dependency graph. Further, based on the dependency graph, the processing circuitry 104 may identify the second digital artifact associated with at least the first digital artifact. In such an embodiment, the processing circuitry 104 may utilize the function-specific agent to determine the first recommended usage pattern further based on the second digital artifact. The determination of the first recommended usage pattern further based on the second digital artifact may ensure that the enhanced first recommended usage pattern enables the first and second entities to work with interconnected digital artifacts of the set of digital artifacts 120, thereby improving understanding of how changes or issues in one digital artifact (for example, at least the first digital artifact) may impact other digital artifacts (for example, the second digital artifact) of the set of digital artifacts 120.

In an embodiment, the processing circuitry 104 may utilize the adaptive agent for query response generation of a user query associated with the first software product. Utilization of the adaptive agent for query response generation is explained in detail in conjunction with FIG. 3.

Although the storage element 106 is shown to include only the navigator agent, cluster agent, function-specific agent, and visualization agent, the scope of the present disclosure is not limited to this configuration. The present disclosure may include multiple instances of each agent within the set of agents. These multiple instances may collectively execute corresponding operations in the determination of recommended usage patterns, such as the first recommended usage pattern. For example, the processing circuitry 104 may deploy multiple navigator agents to handle different types of navigation analysis simultaneously, multiple cluster agents to process various clustering algorithms in parallel, and multiple visualization agents to render different types of visual representations concurrently. Additionally, the function-specific agent may comprise specific specialized agents such as performance agents, security agents, and code refactoring agents, with multiple instances of each function-specific agent type being present in the set of agents to handle their respective operational contexts.

FIG. 2 is a schematic diagram 200 that illustrates a process flow for an exemplary implementation of the usage pattern recommendation system 102, consistent with disclosed embodiments of the present disclosure.

For the sake of brevity, FIG. 2 is explained in conjunction with elements from FIG. 1. Referring to FIG. 2, the usage pattern recommendation system 102 is shown to include the processing circuitry 104 that is coupled to the storage element 106 as described in conjunction with FIG. 1.

As mentioned previously, the storage element 106 is configured to store the set of agents 110 (shown in FIG. 1) and the logic store 112. The set of agents 110 may include the navigator agent (hereinafter, the navigator agent 202), the cluster agent (hereinafter, the cluster agent 204), the function-specific agent (hereinafter, the function-specific agent 206), and the visualization agent (hereinafter, the visualization agent 208). The set of agents 110 may further include the adaptive agent. The adaptive agent is explained in detail in conjunction with FIG. 3.

The processing circuitry 104 may be further configured to access the storage element 106 directly or via the communication network 108 to coordinate various operations executed by each agent of the set of agents 110. In some embodiments, the set of agents 110 may include additional or different agents that may be configured to execute one or more operations associated with the determination of the usage pattern recommendations for the digital artifacts without deviating from the scope of the disclosure.

The set of agents 110 stored in the storage element 106 may refer to a collection of autonomous or semi-autonomous computational modules, each configured to perform specific tasks or subtasks for execution of one or more operations associated with the determination of the usage pattern recommendation (for example, generation of the first recommended usage pattern associated with at least the first digital artifact). The set of agents 110 may include generative artificial intelligence (AI)-based agents and agentic AI-based agents. The generative AI-based agents may utilize generative models (such as large language models or diffusion models) to create content, generate responses, or synthesize data based on learned patterns whereas the agentic AI-based agents may be capable of goal-directed behavior, operate with a degree of autonomy, and may interact with other agents or components to plan, execute, and adapt actions in pursuit of defined objectives and goals, while exhibiting traits such as reasoning, decision-making, and feedback incorporation. Each agent of the set of agents 110 may operate independently or collaboratively with one or more other agents of the set of agents 110. In some embodiments, operations executed by each agent may be coordinated by the processing circuitry 104.

The processing circuitry 104 utilizes the navigator agent 202 to generate the first set of digital pheromone trails (hereinafter, the first set of digital pheromone trails 210) associated with at least the first digital artifact. In an embodiment, the navigator agent 202 may generate the first set of digital pheromone trails 210 based on the set of logic constraints included within the logic store 112. More specifically, the navigator agent 202 may be implemented as an agentic AI-based system. The navigator agent 202 may operate autonomously with goal-directed behavior, decision-making capabilities, and has ability to adapt its actions based on environmental feedback and navigation patterns associated with the first and second entities. The navigator agent 202 may be configured to track and interpret interactions initiated by the first and second entities associated with the display devices 116 and 118. In some embodiments, the navigator agent 202 may monitor both explicit entity inputs (for example, queries, commands, or task specifications) and implicit entity behavior (for example, navigation choices or time spent in a shared workspace environment).

The set of agents 110 may include multiple navigator agents, where each navigator agent may be configured to monitor a specific type of operation associated with a particular category of digital artifacts associated with the first software product. For example, one navigator agent may monitor security-related operations such as authentication processes, authorization checks, and encryption activities associated with security-focused digital artifacts, while another navigator agent may specialize in tracking performance-related operations such as execution timing, resource consumption, and throughput measurements associated with performance-critical digital artifacts.

The processing circuitry 104 utilizes the cluster agent 204 for the generation of the first set of clusters (hereinafter, the first set of clusters 212). In an embodiment, the cluster agent 204 may generate the first set of clusters 212 based on the set of logic constraints included within the logic store 112. More specifically, the cluster agent 204 may be implemented as an agentic AI-based system. The cluster agent 204 may operate autonomously with goal-directed behavior, decision-making capabilities, continuous analyses of code relationships, and dynamically group related elements based on functional similarity, usage patterns, and developer interaction data. The clustering boundaries adapt in real-time as usage patterns evolve. As described in FIG. 1, the cluster agent 204 may be associated with the cluster type that may correspond to its functional specialization and operational scope. The cluster agent 204 may be configured to communicate with the navigator agent 202 based on a matching criterion where a pheromone type of a digital pheromone trail generated by the navigator agent 202 may match with the cluster type of the cluster agent 204. That is to say, a cluster of the set of clusters 212 may be generated based on a match between the cluster type and the pheromone type.

The function-specific agent 206 may refer to a specialized component within the usage pattern recommendation system 102 that is configured to perform targeted analysis and determine usage pattern recommendations based on a particular operational criterion or analytical domain, ensuring that the recommended usage pattern is determined to specific functional requirements and domain expertise. The operational criteria may include factors such as the type of analysis required, the pheromone type associated with the digital pheromone trails, the user's role and objectives, or the specific characteristics of the digital artifacts being analyzed. Based on the operational criteria, the processing circuitry 104 may instantiate the appropriate function-specific agent to handle the specialized analysis requirements. That is to say, function-specific agent 206 is dynamically determined and deployed based on the specific operational criteria of the recommended usage pattern determination process, with a function-specific agent 206 incorporating specialized features and capabilities optimized for its intended function.

More specifically, the function-specific agent 206 may be implemented as an agentic AI-based system. Function-specific agents are inherently domain-focused, meaning that each agent is configured to understand and analyze digital artifacts within a specific functional context. For example, a security agent specializes exclusively in security-related analysis, possessing knowledge of vulnerability patterns, threat vectors, compliance requirements, and risk assessment methodologies. This specialization enables the security agent to determine usage patterns that specifically address security concerns, such as recommending secure navigation paths through authentication modules, suggesting vulnerability assessment workflows, or providing guidance for compliance validation procedures. The domain expertise of the security agent ensures that determined usage patterns incorporate security best practices, regulatory requirements, and threat mitigation strategies that would not be apparent to a generalized analysis approach.

Similarly, a performance agent specializes in performance optimization analysis, possessing expertise in execution efficiency, resource utilization patterns, system bottlenecks, and optimization strategies. When determining usage recommendation patterns, the performance agent focuses on recommendations that enhance system performance, such as suggesting optimal code execution paths, identifying resource-efficient navigation sequences, or recommending performance monitoring workflows. The domain knowledge of the performance agent enables it to determine usage patterns that consider factors such as execution time, memory consumption, CPU utilization, and scalability characteristics that are significant for performance optimization but may be irrelevant for other analytical domains.

A refactoring agent specializes in code improvement and structural analysis, possessing knowledge of design patterns, code quality metrics, technical debt indicators, and refactoring methodologies. The refactoring agent determines usage patterns that focus on code improvement opportunities, such as recommending sequences for identifying similar code structures, suggesting workflows for technical debt assessment, or providing guidance for architectural improvement analysis. The specialization of the refactoring agent ensures that generated usage patterns incorporate best practices, maintainability considerations, and structural optimization strategies.

For instance, when a security agent determines a usage pattern recommendation for vulnerability assessment, the security agent determines a usage pattern recommendation that facilitates navigation of users through security-specific workflows such as dependency analysis for identifying vulnerable libraries, code path analysis for detecting potential attack vectors, or compliance validation for ensuring regulatory adherence. These recommended usage patterns are fundamentally different from those generated by a performance agent, which might focus on profiling workflows, bottleneck identification procedures, or optimization validation processes.

Notably, function-specific agent 206 and navigator agent 202 may have distinct responsibilities for maintaining and updating digital pheromone trails. The evaporation function may be applied by a function-specific agent, leveraging the corresponding domain expertise to determine appropriate decay rates and evaporation parameters based on the specific characteristics of the corresponding analytical domain. For example, a security agent may apply evaporation functions with slower decay rates for significant security pathways to ensure that important security-related navigation patterns remain available for extended periods, while applying faster decay rates to less significant security pathways to prevent outdated security practices from persisting in the system 102. Conversely, the activation function may be applied by the navigator agent 202. When the navigator agent 202 detects that users (namely, the first and second entities) are following recommended usage patterns, they apply activation functions to increment usage scores and reinforce successful navigation pathways.

To summarize, the function-specific agent 206 enables the usage pattern recommendation system 102 to provide specialized, context-aware analysis that is associated with the specific operational requirements and analytical objectives of each usage scenario, ensuring that recommended usage patterns, for example, the first recommended usage pattern, are both relevant and actionable for the intended purpose.

The processing circuitry 104 may utilize the visualization agent 208 to generate, based on a recommended usage pattern (for example, the first recommended usage pattern) or the or the navigation pattern type, an visualization interface (for example, the visualization interface 130) that presents the first recommended usage pattern (hereinafter, the first recommended usage pattern 214) associated with at least the first digital artifact. The visualization agent 208 may render the visualization interface 130 via the display device 116 associated with the system 102.

More specifically, the visualization agent 208 may be implemented as an agentic AI-based system. In an embodiment, the visualization interface 130 may be dynamic and adaptive, such that the visualization interface 130 may adapt the interface based on the type of the navigation pattern. For example, the navigation pattern type of the first navigation pattern may correspond to the security navigation pattern type, and the first recommended usage pattern 214 may be indicative of security and vulnerability issues associated with the one or more digital artifacts of the set of digital artifacts 120 included within the first cluster. In such an example, the function-specific agent 206 of security agent type may be further configured to compute a risk severity metric representing the overall level of security risk associated with at least the first digital artifact based on factors such as likelihood and impact analysis of the security and vulnerability issues associated with at least the first digital artifact. The likelihood may refer to a metric that indicates how probable it is for the security and vulnerability issues associated with the first digital artifact to occur. The impact may measure how serious the consequences would be if the security and vulnerability issues were actually exploited, such as exposing sensitive data or allowing attackers to gain full access to the client computing system 114. In some embodiments, the risk severity metric may correspond to a risk score. Thus, the risk score may be computed as:

Risk score=Likelihood*Impact

In an embodiment, the security agent may be configured to determine the risk score based on the set of logic constraints included within the logic store 112. Further, based on the navigation pattern type of the first navigation pattern being the security navigation pattern type, the visualization agent 208 may be configured to generate, based on the first recommended usage pattern 214, a heat map for at least the first digital artifact. Notably, the heat map may be indicative of a risk severity metric associated with at least the first digital artifact. The visualization agent 208 may be further configured to render the heat map via the display device 116 associated with the system 102. In an embodiment, the visualization agent 208 may generate the visualization interface 130 with the security-critical nodes associated with at least the first digital artifact being highlighted in red to indicate high-severity vulnerabilities, while orange may be used to represent medium or lower severity issues. Each node associated with at least the first digital artifact may be tagged with the corresponding severity score, thereby enabling the first entity or the second entity to quickly assess, via the corresponding display devices (for example, the display devices 116 or 118), the level of risk. Additionally, visualization interface 130 may render risk propagation pathways as thick red connections between related digital artifacts of the set of digital artifacts 120, thereby enabling the first or second entity, via the corresponding display devices (for example, the display devices 116 or 118), to visualize how security risks may spread across the client computing system 114.

In an embodiment, the processing circuitry 104 may be further configured to utilize the cluster agent 204 to generate a second cluster for a second digital pheromone trail of the first set of digital pheromone trails 210, such that the second cluster includes at least the first digital artifact. The second cluster may be generated in a manner similar to as described for the generation of the first cluster. Notably, the second cluster is generated based on the first usage score associated with the second digital pheromone trail exceeding the first threshold usage score. The cluster agent 204 may be further configured to determine, based on the second cluster, a second recommended usage pattern associated with at least the first digital artifact. The second recommended usage pattern may be determined in a manner similar to as described for the first recommended usage pattern 214.

Notably, the second recommended usage pattern is indicative of a second navigation pattern, of the first set of navigation patterns, represented by the second digital pheromone trail, in a manner similar to the first recommended usage pattern 214 being indicative of the first navigation pattern, of the first set of navigation patterns, represented by the first digital pheromone trail. The processing circuitry 104 may be further configured to utilize the visualization agent 208 to render, via the display device 116 associated with the system 102, the second recommended usage pattern. The second recommended usage pattern may be rendered in a manner similar to as described for the first recommended usage pattern 214. Notably, the second recommended usage pattern may also be rendered via the display device 118 to the second entity. The second cluster may represent a distinct operational context and usage scenario for at least the first digital artifact, indicating that at least the first digital artifact may serve multiple functional roles within different workflows and operational domains.

In an embodiment, the cluster agent 204 may be configured to determine, based on the first plurality of operational attribute values, a first recency score associated with the first digital pheromone trail. As used herein, the term recency score may refer to a temporal metric that indicates how recently a navigation pattern (for example, the first navigation pattern) associated with a digital pheromone trail (for example, the first digital pheromone trail) has been traversed or accessed. In other words, the first recency score may be indicative of a time-instance of a most recent traversal of the first navigation pattern associated with the first digital pheromone trail.

The recency score (for example, the first recency score) may be calculated based on the time elapsed since the most recent traversal of a navigation pattern (for example, the first navigation pattern). A higher recency score may typically indicate more recent activity. The recency score may be computed using various temporal weighting functions, such as exponential decay models or linear time-based scoring, to reflect the recency of usage of a navigation pattern. For example, a navigation pattern accessed within the last day may receive a higher recency score than one accessed a week ago, emphasizing the temporal relevance of the usage of the navigation pattern.

The cluster agent 204 may be further configured to generate the first cluster for the first digital pheromone trail based on the first recency score exceeding a recency threshold score. Thus, the cluster agent 204 may be further configured to generate the first cluster based on at least one of the first usage score associated with the first digital pheromone trail exceeding the first threshold usage score or the first recency score exceeding the recency threshold score. Notably, the first recency score exceeding the recency threshold score may indicate that the first digital pheromone trail has been recently active and therefore represents a current and relevant navigation pattern within the first software product. In an embodiment, the cluster agent may determine the recency threshold score based on the set of logic constraints included within the logic store 112. In an embodiment, the cluster agent 204 may be configured to generate the first cluster based on a combination of the first usage score and the first recency score. The combination of the first usage score and the first recency score may ensure that the generated first cluster may represent both highly utilized and current navigation patterns, providing meaningful insights for overall optimization of the first software product, user experience enhancement, and development prioritization decisions.

In some embodiments, processing circuitry 104 may be configured to render, via the display device 116 associated with the system 102, a third recommended usage pattern associated with a third digital artifact in a manner similar to as explained for the first recommended usage pattern 214. That is to say, the navigator agent 202 may be configured to determine a second plurality of operational attribute values for the plurality of operational attributes pertaining to each of a second plurality of operations associated with the third digital artifact of the set of digital artifacts 120, in a manner similar to as explained for the determination of the first plurality of operational attribute values. The navigator agent 202 may be configured to generate, based on the second plurality of operational attribute values, a second set of digital pheromone trails associated with the third digital artifact in a manner similar to as explained for the first set of digital pheromone trails 210. Notably, the second set of digital pheromone trails may represent a second set of navigation patterns associated with the third digital artifact, similar to as described for the first set of digital pheromone trails 210. The cluster agent 204 may be further configured to determine, based on the second plurality of operational attribute values, a second usage score associated with each digital pheromone trail of the second set of digital pheromone trails in a manner similar to as described for the determination of the first usage score associated with each digital pheromone trail of the first set of digital pheromone trails 210. Notably, the second usage score may be indicative of traversal frequency of a navigation pattern associated with the digital pheromone trail in a manner similar to the first usage score being indicative of the traversal frequency of the navigation pattern (for example, the first navigation pattern) associated with the digital pheromone trail (for example, the first digital pheromone trail).

The cluster agent 204 may be further configured to generate a third cluster for a third digital pheromone trail of the second set of digital pheromone trails based on the second usage score associated with the third digital pheromone trail exceeding a second threshold usage score in a manner similar to as described for the first cluster. Notably, the third cluster includes the third digital artifact in a manner similar to as described for the first cluster, including at least the first digital artifact. The function-specific agent 206 may be further configured to determine, based on the third cluster, the third recommended usage pattern associated with the third digital artifact in a manner similar to as described for the first recommended usage pattern 214. Notably, the third recommended usage pattern is indicative of a third navigation pattern, of the second set of navigation patterns, represented by the third digital pheromone trail in a manner similar to the first recommended usage pattern 214 being indicative of the first navigation pattern. The visualization agent 208 may be further configured to render, via the display device 116 or the display device 118 associated with the system 102, the third recommended usage pattern.

In some embodiments, based on one or more digital pheromone trails of the first set of digital pheromone trails 210, having the same pheromone type, one or more recommended usage patterns may be determined for at least the first digital artifact. For example, based on the one or more digital pheromone trails associated with a security pheromone type, the one or more recommended usage patterns may be determined, having a security navigation pattern type. Notably, each of the security pheromone trails may have a high usage score. However, each of the one or more digital pheromone trails may be associated with a specific functional context. As the one or more recommended usage patterns are determined based on the one or more digital pheromone trails having a security pheromone type, each of the one or more recommended usage patterns may be indicative of security related usage patterns. Further, each of the one or more recommended usage patterns may be associated with a function-specific score. For example, the first recommended usage pattern 214 may be associated with a first function-specific score. Further, in case of a security related issue associated with at least the first digital artifact, the function-specific agent 206 may be configured to determine the function-specific score associated with each of the one or more recommended usage patterns.

The function-specific agent 206 may determine the function-specific scores based on analysis of various factors, including but not limited to task-specific effectiveness, user role alignment, contextual relevance, success rates for particular use cases, or the like. The function-specific score may correspond to a metric that quantifies the suitability of each of the one or more recommended usage patterns for a given task, user role, or operational context. In an embodiment, the first function-specific score may be determined based on the usage score or the recency score. In an embodiment, the function-specific agent 206 may determine that the first function-specific score associated with the first recommended usage pattern 214 is higher than the function-specific score associated with each of remaining recommended usage patterns of the one or more recommended usage patterns.

The function-specific agent 206 may be further configured to generate a set of feedback associated with the first recommended usage pattern 214 based on the first function-specific score. The set of feedback may be generated based on recency of usage of the first recommended usage pattern 214, frequency of usage of the first recommended usage pattern 214, operational context of the first recommended usage pattern 214, or the like. The set of feedback that may facilitate the first and second entities in selecting the most appropriate recommended usage pattern, for example, the first recommended usage pattern 214. Further, the visualisation agent 208 may be configured to render the set of feedback via the display device 116 or the display device 118 associated with the system 102.

The specific tasks or subtasks performed by each agent of the set of agents 110, such as navigator agent 202, cluster agent 204, function-specific agent 206 (including the performance agent, security agent, and refactoring agent), and the visualisation agent 208, are implemented through computational algorithms and control mechanisms derived from swarm intelligence, where such methods utilize distributed, cooperative, and self-organizing behaviours analogous to those observed in natural swarm systems. Swarm intelligence refers to a class of algorithms that emulate the collective behaviour and decentralized coordination exhibited by biological populations such as ant colonies, bird flocks, and bee swarms. These swarm-based computational techniques enable adaptive, self-organizing, and optimized decision-making across the system 102. For example, each agent of the set of agents 110 implements various swarm intelligence based algorithms, including but not limited to ant colony optimization (ACO), particle swarm optimization (PSO), artificial bee colony (ABC) optimization, swarm-based clustering, pheromone-based communication, graph-based swarm optimization, or the like. Collectively, these swarm intelligence derived methods facilitate distributed coordination, adaptive task management, and optimized system operation within the architecture of the present disclosure.

FIG. 3 is a schematic diagram 300 that illustrates a process flow for resolution of a query associated with the usage pattern recommendation system 102, consistent with disclosed embodiments of the present disclosure.

For the sake of brevity, FIG. 3 is explained in conjunction with elements from FIGS. 1-2. Referring to FIG. 3, the usage pattern recommendation system 102 is shown to include the processing circuitry 104 that is coupled to the storage element 106 as described in conjunction with FIGS. 1-2. As mentioned previously, the set of agents 110 may be further configured to include the adaptive agent (hereinafter, the adaptive agent 302).

The processing circuitry 104 utilizes the adaptive agent 302 to coordinate and manage the interactions, communications, and workflow sequences between one or more agents of the set of agents 110. More specifically, the adaptive agent 302 may be implemented as an agentic AI-based system. The adaptive agent 302 may operate autonomously with goal-directed behavior and has functions as an orchestrator for the remaining agents in the set of agents 110.

As described above, the logic store 112 may include rules, constraints, and decision-making logic that may orchestrate how each agent of the set of agents 110 operates and interacts within the usage pattern recommendation system 102. The logic store 112 may further include predefined logic constraints that define agent behaviors, query processing rules, inter-agent communication protocols, and decision trees for determining appropriate analysis approaches.

In an embodiment, the first entity may submit a user query such as “What are the performance hotspots associated with at least the first digital artifact?” via the visualization interface 130 of the display device 116. The adaptive agent 302 may access the user query associated with at least the first digital artifact. Further, the adaptive agent 302 may access the logic store 112 to determine a context associated with the user query and an appropriate query decomposition strategy. The query decomposition strategy may specify the rules and logic for partitioning complex queries into intermediate sub-queries and assigning specific query components to designated agents for execution. Further, based on the rules and constraints in the logic store 112, the adaptive agent 302 may determine the context of the user query. Based on the context of the user query and the rules and constraints in the logic store 112, the adaptive agent 302 may generate a set of intermediate queries. Notably, the set of intermediate queries may, collectively, correspond to the context associated with the user query.

In an embodiment, the logic store 112 provides rules for intermediate query generation, ensuring that the intermediate queries are formulated in formats such that each agent of the set of agents 110 may process a corresponding subset of intermediate queries effectively. For example, the logic store 112 may contain rules specifying that performance-related queries should include navigation components, clustering requirements, function-specific analysis needs, and visualization specifications. In an embodiment, the adaptive agent 302 may access these rules stored in the logic store 112 and generate the set of intermediate queries based on these rules.

The adaptive agent 302 may further communicate at least a subset of intermediate queries of the set of intermediate queries to at least one of the navigator agent 202, the cluster agent 204, the function-specific agent 206, and the visualization agent 208. For example, the adaptive agent 302 may communicate the navigation-related intermediate query to the navigator agent 202. The navigator agent 202 may determine a digital pheromone trail having a performance pheromone type associated with at least the first digital artifact. The navigator agent 202 may further communicate the determined digital pheromone trail to the adaptive agent 302. The adaptive agent 302 may receive at least a first portion associated with a query response 304 from at least one of the navigator agent 202, the cluster agent 204, the function-specific agent 206, and the visualization agent 208.

The adaptive agent 302 may receive the determined digital pheromone trail from the navigator agent 202. That is to say, the adaptive agent 302 may receive at least the first portion associated with the query response 304 from the navigator agent 202. The adaptive agent 302 may further communicate the determined digital pheromone trail to the cluster agent 204. The cluster agent 204 may identify a cluster based on the digital pheromone trail. The cluster may include at least the first digital artifact. That is to say, the cluster may include one or more digital artifacts of the set of digital artifacts 120. The cluster agent 204 may further communicate the identified cluster to the adaptive agent 302. The adaptive agent 302 may receive the cluster from the cluster agent 204. That is to say, the adaptive agent 302 may receive a second portion associated with the query response 304 from the cluster agent 204. The adaptive agent 302 may further communicate the cluster to the function-specific agent 206. Based on the context of the user query, the processing circuitry 104 may be further configured to deploy the performance agent as the function-specific agent 206 for user query resolution. The performance agent may determine the performance hotspots associated with each digital artifact included within the cluster. The performance agent may further determine, based on the cluster, a recommended usage pattern. The performance agent may further communicate the recommended usage pattern to the adaptive agent 302. The adaptive agent 302 may receive the recommended usage pattern from the function-specific agent 206 (namely, the performance agent). That is to say, the adaptive agent 302 may receive a third portion associated with the query response 304 from the function-specific agent 206. The adaptive agent 302 may further generate, in response to the user query, the query response 304 based on at least the first portion associated with the query response 304. In the ongoing discussion, the adaptive agent 302 may generate the query response based on at least the first portion, the second portion, and the third portion, which are associated with the query response 304. The adaptive agent 302 may further communicate the query response 304 to the visualization agent 208. The visualization agent 208 may be further configured to render, via the display device 116 associated with the system 102, the query response 304 by way of the visualization interface 130. Notably, the visualization interface 130 is adaptive, such that visualization interface 130 visualizes data, usage recommendation patterns, query responses, or the like, in real time based on user role and query context. Similarly, the visualization interface 132 may adapt in real time.

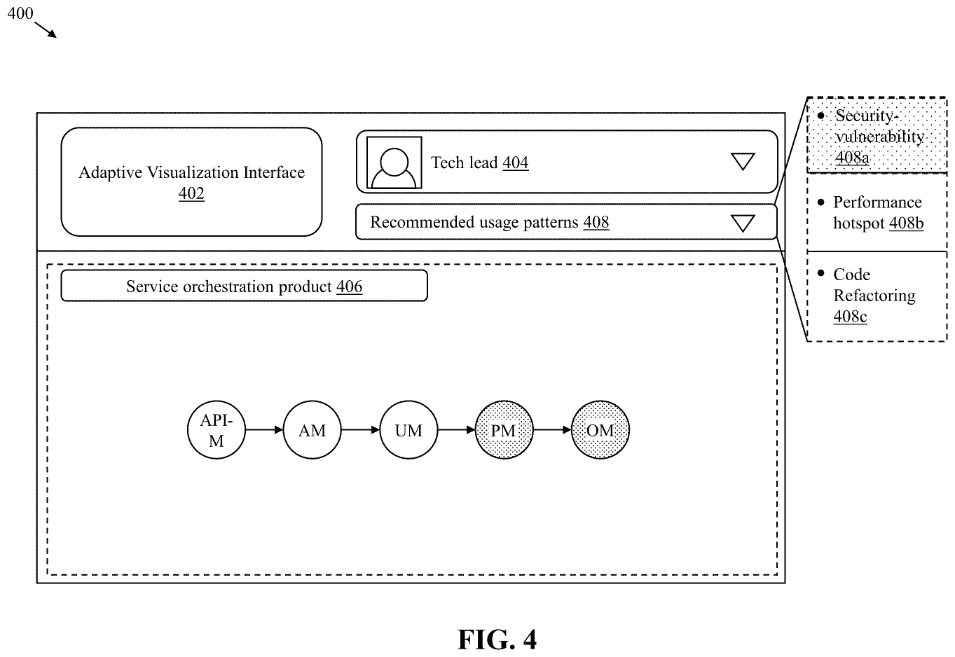

FIG. 4 illustrates a schematic diagram 400 depicting an exemplary visualization interface rendering recommended usage patterns for a service orchestration product associated with the usage pattern recommendation system 102, consistent with disclosed embodiments of the present disclosure.

Referring to FIG. 4, the exemplary visualization interface corresponds to a visualization interface 402, which serves as the primary user interface for rendering recommended usage patterns, shown at a given instance in time. The interface 402 includes an option to select or display a user role, as demonstrated by a tech lead 404, which represents a stakeholder accessing the visualization interface 402.

The visualization interface 402 displays a visualization corresponding to the service orchestration product (hereinafter, the service orchestration product 406), which represents a software project or application domain containing multiple related digital artifacts. The visualization interface 402 presents multiple code modules associated with the service orchestration product 406. The presented code modules are shown to include an order management code module denoted as “OM”, which is a first code module or a first digital artifact within the service orchestration product 406, a user profile code module denoted as “UM” which is a second code module or a second digital artifact within the service orchestration product 406, a payment code module denoted as “PM” which is a third code module or a third digital artifact within the service orchestration product 406, an authorization code module denoted as “AM” which is a fourth code module or a fourth digital artifact within the service orchestration product 406, and an API gateway code module denoted as “API-M” which is a fifth code module or a fifth digital artifact within the service orchestration product 406.

The visualization interface 402 is further shown to include a recommended usage patterns button 408. Upon clicking the recommended usage patterns button 408, an interactive visualization pane may be rendered, revealing all the recommended usage patterns associated with the first through fifth modules. The interactive visualization pane provides a selection mechanism enabling a user to specify which recommended usage pattern is to be rendered. These recommended usage patterns may include, for example, security vulnerability 408a, performance hotspot 408b, code refactoring 408c, or the like.

Consider a scenario where a security vulnerability is identified in the service orchestration product 406, specifically a privilege escalation bug that allows unauthorized users to access sensitive payment information through improper authorization checks. To resolve this security issue, a recommended usage pattern is determined by the processing circuitry 104 of the usage pattern recommendation system 102 that defines a specific sequence of module traversals required for comprehensive bug analysis and remediation.

The security-related recommended usage pattern may begin at the API gateway code module, where the initial security breach point is identified through improper input validation. From there, the recommended usage pattern directs users to traverse to the authorization code module to examine the flawed permission verification logic that enables the privilege escalation. The sequence then proceeds to the user profile code module to analyze how user roles and permissions are managed and potentially compromised. Next, the recommended usage pattern navigates users to the payment code module to assess the exposure of sensitive financial data and implement additional security controls. The traversal concludes at the order management code module to evaluate how the security vulnerability affects transaction processing and order handling workflows.

This recommended usage pattern is categorized as security-related due to the focus on vulnerability analysis, privilege escalation prevention, and sensitive data protection. When the tech lead 404 clicks on the recommended usage patterns button 408 for security type, for example, the security vulnerability 408a within the visualization interface 402, this recommended usage pattern will be displayed, showing the interconnected modules as nodes with directional arrows indicating the recommended sequence: API Gateway code module, authorization code module, user profile code module, payment code module, and order management code module. To indicate that the tech lead 404 has clicked the security vulnerability 408a, the security vulnerability 408a is displayed in a darker shade. Further, each module node may be color-coded or highlighted to indicate security risk levels. For example, the payment code module and the order management code module are displayed with darker shades to indicate high risk due to handling of sensitive financial data and transaction processing, while other modules may be shown with lighter shades corresponding to lower risk levels.

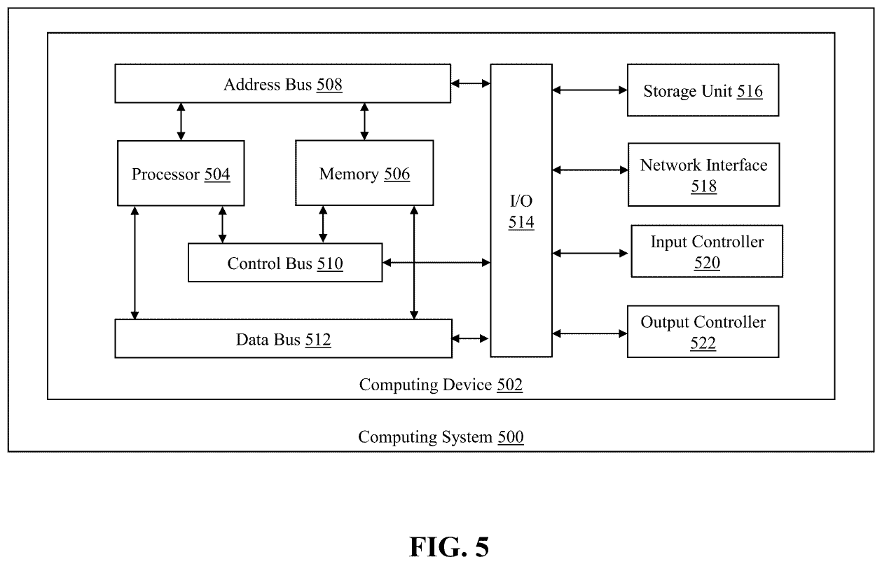

FIG. 5 shows an example computing system 500 for carrying out the methods of the present disclosure, consistent with disclosed embodiments of the present disclosure. Specifically, FIG. 5 shows a block diagram of an embodiment of the computing system 500 according to example embodiments of the present disclosure.

The computing system 500 may be configured to perform any of the operations disclosed herein. The computing system 500 may be implemented as a conventional computer system, an embedded controller, a laptop, a server, a mobile device, a smartphone, a customized machine, any other hardware platform, or any combination or multiplicity thereof. In one embodiment, the computing system 500 is a distributed system configured to function using multiple computing machines interconnected via a data network or bus system.

The computing system 500 includes computing devices (such as a computing device 502). The computing device 502 includes one or more processors (such as a processor 504) and a memory 506. The processor 504 may be any general-purpose processor(s) configured to execute a set of instructions. For example, the processor 504 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 504 may be multiple processing units, a single processing core, multiple processing cores, special purpose processing cores, co-processors, or any combination thereof. The processor 504 may be communicatively coupled to the memory 506 via an address bus 508, a control bus 510, and a data bus 512.

The memory 506 may include non-volatile memories such as a read-only memory (ROM), a programable read-only memory (PROM), an erasable programmable read-only memory (EPROM), a flash memory, or any other device capable of storing program instructions or data with or without applied power. The memory 506 may also include volatile memories, such as a random-access-memory (RAM), a static random-access-memory (SRAM), a dynamic random-access-memory (DRAM), and a synchronous dynamic random-access-memory (SDRAM). The memory 506 may include single or multiple memory modules. While the memory 506 is depicted as part of the computing device 502, a person skilled in the art may recognize that the memory 506 may be separate from the computing device 502.

The memory 506 may store information that may be accessed by the processor 504. For instance, the memory 506 (e.g., one or more non-transitory computer-readable storage mediums, memory devices) may include computer-readable instructions (not shown) that may be executed by the processor 504. The computer-readable instructions may be software written in any suitable programming language or may be implemented in hardware. Additionally, or alternatively, the computer-readable instructions may be executed in logically and/or virtually separate threads on the processor 504. For example, the memory 506 may store instructions (not shown) that, when executed by the processor 504, cause the processor 504 to perform operations such as any of the operations and functions for which the computing system 500 is configured, as described herein. Additionally, or alternatively, the memory 506 may store data (not shown) that may be obtained, received, accessed, written, manipulated, created, and/or stored. The data may include, for instance, the data and/or information described herein in relation to FIG. 1-4. In some implementations, the computing device 502 may obtain from and/or store data in one or more memory device(s) that are remote from the computing system 500.

The computing device 502 may further include an input/output (I/O) interface 514 communicatively coupled to the address bus 508, the control bus 510, and the data bus 512. The data bus 512 may include a plurality of tunnels that may support communication in the environment 100. The I/O interface 514 is configured to couple to one or more external devices (e.g., to receive and send data from/to one or more external devices). Such external devices, along with the various internal devices, may also be known as peripheral devices. The I/O interface 514 may include both electrical and physical connections for operably coupling the various peripheral devices to the computing device 502. The I/O interface 514 may be configured to communicate data, addresses, and control signals between the peripheral devices and the computing device 502. The I/O interface 514 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, and the like. The I/O interface 514 is configured to implement only one interface or bus technology. Alternatively, the I/O interface 514 is configured to implement multiple interfaces or bus technologies. The I/O interface 514 may include one or more buffers for buffering transmissions between one or more external devices, internal devices, the computing device 502, or the processor 504. The I/O interface 514 may couple the computing device 502 to various input devices, including touch screens, scanners, biometric readers, electronic digitizers, receivers, touchpads, cameras, keyboards, any other pointing devices, or any combinations thereof. The I/O interface 514 may couple the computing device 502 to various output devices, including printers, projectors, tactile feedback devices, automation control, robotic components, actuators, transmitters, signal emitters, lights, and so forth.

The computing system 500 may further include a storage unit 516, a network interface 518, an input controller 520, and an output controller 522. The storage unit 516, the network interface 518, the input controller 520, and the output controller 522 are communicatively coupled to the central control unit (e.g., the memory 506, the address bus 508, the control bus 510, and the data bus 512) via the I/O interface 514. The network interface 518 communicatively couples the computing system 500 to one or more networks such as wide area networks (WAN), local area networks (LAN), intranets, the Internet, wireless access networks, wired networks, mobile networks, telephone networks, optical networks, or combinations thereof. The network interface 518 may facilitate communication with packet-switched networks or circuit-switched networks, which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 516 is a computer-readable medium, preferably a non-transitory computer-readable medium, comprising one or more programs, the one or more programs comprising instructions that, when executed by the processor 504, cause the computing system 500 to perform the method steps of the present disclosure. Alternatively, the storage unit 516 is a transitory computer-readable medium. The storage unit 516 may include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 516 stores one or more operating systems, application programs, program modules, data, or any other information. The storage unit 516 is part of the computing device 502. Alternatively, the storage unit 516 is part of one or more other computing machines that are in communication with the computing device 502, such as servers, database servers, cloud storage, network attached storage, and so forth.

The input controller 520 may include suitable logic, circuitry, interfaces, and/or code, executable by the circuitry, that may be configured to control one or more input devices that may be configured to receive the digital artifacts.

In some embodiments, a computer-readable medium is disclosed. The computer-readable medium includes instructions that, when executed by processing circuitry that includes the processor 504 of the computing system 500, cause the computing system 500 to perform a method for facilitating usage pattern recommendation for digital artifacts. The method includes determining, by the processing circuitry, a first plurality of operational attribute values for a plurality of operational attributes pertaining to each of a first plurality of operations associated with at least a first digital artifact of a set of digital artifacts stored in a storage element. The method further includes generating, by the processing circuitry, based on the first plurality of operational attribute values for the plurality of operational attributes pertaining to each of the first plurality of operations, a first set of digital pheromone trails associated with at least the first digital artifact. The first set of digital pheromone trails represents a first set of navigation patterns associated with at least the first digital artifact. The method further includes determining, by the processing circuitry, based on the first plurality of operational attribute values, a first usage score associated with each digital pheromone trail of the first set of digital pheromone trails. The first usage score is indicative of traversal frequency of a navigation pattern associated with the digital pheromone trail. The method further includes generating, by the processing circuitry, a first cluster for a first digital pheromone trail of the first set of digital pheromone trails based on the first usage score associated with the first digital pheromone trail exceeding a first threshold usage score. The first cluster includes at least the first digital artifact. The method further include determining, by the processing circuitry, based on the first cluster, a first recommended usage pattern associated with at least the first digital artifact. The first recommended usage pattern is indicative of a first navigation pattern of the first set of navigation patterns represented by the first digital pheromone trail. The method further includes rendering, by the processing circuitry, via a display device, the first recommended usage pattern.

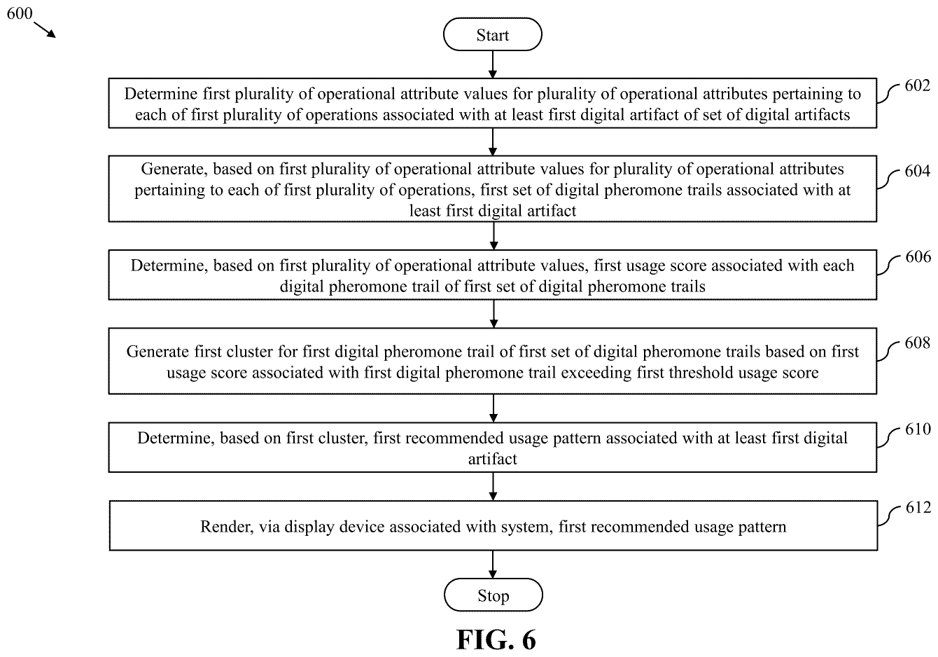

FIG. 6 is a flowchart 600 that illustrates a method that facilitates usage pattern recommendation for digital artifacts, consistent with disclosed embodiments of the present disclosure. Referring to FIG. 6, the method may be implemented by the usage pattern recommendation system 102 using one or more agents stored in the storage element 106 and executed by the processing circuitry 104.

At step 602, the first plurality of operational attribute values for the plurality of operational attributes pertaining to each of the first plurality of operations associated with at least the first digital artifact of the set of digital artifacts 120 stored in the storage element 106 may be determined. The processing circuitry 104 may determine the first plurality of operational attribute values for the plurality of operational attributes pertaining to each of the first plurality of operations associated with at least the first digital artifact of the set of digital artifacts 120. The processing circuitry 104 may utilize the navigator agent 202 for determination the first plurality of operational attribute values for the plurality of operational attributes pertaining to each of the first plurality of operations associated with at least the first digital artifact of the set of digital artifacts 120.

At step 604, based on the first plurality of operational attribute values for the plurality of operational attributes pertaining to each of the first plurality of operations, the first set of digital pheromone trails 210 associated with at least the first digital artifact may be generated. The first set of digital pheromone trails 210 represents the first set of navigation patterns associated with at least the first digital artifact. The processing circuitry 104 may generate, based on the first plurality of operational attribute values for the plurality of operational attributes pertaining to each of the first plurality of operations, the first set of digital pheromone trails 210 associated with at least the first digital artifact. The processing circuitry 104 may utilize the navigator agent 202 for generation of the first set of digital pheromone trails 210 associated with at least the first digital artifact based on the first plurality of operational attribute values for the plurality of operational attributes pertaining to each of the first plurality of operations.

At step 606, based on the first plurality of operational attribute values, the first usage score associated with each digital pheromone trail of the first set of digital pheromone trails 210 may be determined. The first usage score is indicative of traversal frequency of the navigation pattern associated with the digital pheromone trail. The processing circuitry 104 may determine based on the first plurality of operational attribute values, the first usage score associated with each digital pheromone trail of the first set of digital pheromone trails 210. The processing circuitry 104 may utilize the cluster agent 204 for determination of the first usage score associated with each digital pheromone trail of the first set of digital pheromone trails 210 based on the first plurality of operational attribute values.

At step 608, the first cluster for the first digital pheromone trail of the first set of digital pheromone trails 210 based on the first usage score associated with the first digital pheromone trail exceeding the first threshold usage score may be generated. The first cluster includes at least the first digital artifact. The processing circuitry 104 may generate, based on the first usage score associated with the first digital pheromone trail exceeding the first threshold usage score, the first cluster for the first digital pheromone trail of the first set of digital pheromone trails 210. The processing circuitry 104 may utilize the cluster agent 204 for generation of the first cluster for the first digital pheromone trail of the first set of digital pheromone trails 210 based on the first usage score associated with the first digital pheromone trail exceeding the first threshold usage score.

At step 610, the first recommended usage pattern 214 associated with at least the first digital artifact may be determined based on the first cluster. The first recommended usage pattern 214 is indicative of the first navigation pattern, of the first set of navigation patterns, represented by the first digital pheromone trail. The processing circuitry 104 may determine based on the first cluster, the first recommended usage pattern 214 associated with at least the first digital artifact. The processing circuitry 104 may utilize the function-specific agent 206 for determination of the first recommended usage pattern 214 associated with at least the first digital artifact based on the first cluster.

At step 612, the first recommended usage pattern 214 may be rendered, via the display device 116 associated with the usage pattern recommendation 102. The processing circuitry 104 may render, via the display device 116 associated with the usage pattern recommendation system 102, the first recommended usage pattern 214. The processing circuitry 104 may utilize the visualization agent 208 for rendering, via the display device 116 associated with the usage pattern recommendation 102, the first recommended usage pattern 214.

It will be apparent to a person skilled in the art that a first element (for example, a first digital artifact) mentioned in the claims may correspond to a second element described in the specification, and vice versa.

The disclosed system 102 offers significant advantages, including automated adjustments of usage recommendations based on actual usage patterns, ensuring that highly utilized and effective usage patterns remain prominent while obsolete patterns fade away. The continuous updating mechanism may ensure that recommended usage patterns reflect current system behavior rather than historical data, making recommendations more relevant to present conditions and user needs. The system 102 becomes sensitive to changes in development practices, user behavior, or system architecture, automatically adapting the usage pattern recommendations as the software product (for example, the first software product) evolves over time.

The system 102 generates personalized, context-aware recommendations that consider user roles, expertise levels, current operational objectives, and specific system conditions. This targeted guidance significantly reduces cognitive load on developers and analysts while improving the effectiveness of diagnostic and optimization activities. By automatically capturing and encoding successful navigation patterns, diagnostic approaches, and resolution strategies as digital pheromone trails, the system facilitates seamless knowledge transfer between team members and preserves institutional knowledge that would otherwise be lost due to personnel changes or project transitions.

The distributed agent-based architecture enables the system 102 to scale efficiently across large, complex software ecosystems, simultaneously analyzing multiple digital artifacts and providing specialized guidance for different functional domains without performance degradation or resource conflicts. Through intelligent clustering of related digital artifacts (for example, the first cluster) and provision of optimized navigation patterns, the system 102 significantly reduces the time required to identify root causes of functional discrepancies, implement effective solutions, and validate remediation efforts.

By continuously monitoring operational attribute trends and pattern evolution, the system 102 can identify potential issues before they manifest as functional discrepancies, enabling proactive maintenance and preventing system degradation. The system 102 provides dynamic, context-aware visualizations that adapt to user needs, operational contexts, and system conditions, presenting information in the most effective format for the current situation and user objectives.

A person of ordinary skill in the art may appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for facilitating usage pattern recommendation for digital artifacts. While various embodiments of the disclosed systems and methods have been described above, they have been presented for purposes of example only, and not limitations. It is not exhaustive and does not limit the present disclosure to the precise form disclosed. Modifications and variations are possible considering the above teachings or may be acquired from practicing the present disclosure, without departing from the breadth or scope.

What is claimed is:

1. A system, comprising:
a storage element configured to store a set of digital artifacts; and
processing circuitry coupled to the storage element, wherein the processing circuitry is configured to:
determine a first plurality of operational attribute values for a plurality of operational attributes pertaining to each of a first plurality of operations associated with at least a first digital artifact of the set of digital artifacts;
generate, based on the first plurality of operational attribute values for the plurality of operational attributes pertaining to each of the first plurality of operations, a first set of digital pheromone trails associated with at least the first digital artifact, wherein the first set of digital pheromone trails represents a first set of navigation patterns associated with at least the first digital artifact;
determine, based on the first plurality of operational attribute values, a first usage score associated with each digital pheromone trail of the first set of digital pheromone trails, wherein the first usage score is indicative of traversal frequency of a navigation pattern associated with the digital pheromone trail;
generate a first cluster for a first digital pheromone trail of the first set of digital pheromone trails based on the first usage score associated with the first digital pheromone trail exceeding a first threshold usage score, wherein the first cluster includes at least the first digital artifact;
determine, based on the first cluster, a first recommended usage pattern associated with at least the first digital artifact, wherein the first recommended usage pattern is indicative of a first navigation pattern, of the first set of navigation patterns, represented by the first digital pheromone trail; and
render, via a display device associated with the system, the first recommended usage pattern.

2. The system of claim 1, wherein the processing circuitry is further configured to:
detect a traversal operation associated with the first recommended usage pattern;
increment, based on the detection of the traversal operation, the first usage score associated with the first digital pheromone trail in accordance with an activation function; and
continuously decrement the first usage score in accordance with an evaporation function associated with the first recommended usage pattern.

3. The system of claim 1, wherein the plurality of operational attributes include at least two of: a functional attribute associated with at least the first digital artifact, a non-functional attribute associated with at least the first digital artifact, or a hidden attribute associated with at least the first digital artifact.

4. The system of claim 1, wherein the storage element is further configured to store at least one of: a navigator agent, a cluster agent, a visualization agent, an adaptive agent, or a function-specific agent.

5. The system of claim 4, wherein the processing circuitry is further configured to utilize the navigator agent to generate the first set of digital pheromone trails, and wherein the navigator agent is configured to:
determine operational metadata corresponding to the first plurality of operations associated with at least the first digital artifact, wherein the first plurality of operational attribute values for the plurality of operational attributes is determined based on the operational metadata; and
generate, based on at least one of: the first plurality of operational attribute values or the operational metadata, the first set of digital pheromone trails.

6. The system of claim 5, wherein the processing circuitry is further configured to utilize the cluster agent to generate the first cluster, and wherein the cluster agent is configured to:
acquire the first plurality of operational attribute values for the plurality of operational attributes from the navigator agent;
determine, based on the first plurality of operational attribute values, at least one of: the first usage score associated with the first digital pheromone trail or a first recency score associated with the first digital pheromone trail, wherein the first recency score is indicative of a time-instance of a most recent traversal of the first navigation pattern associated with the first digital pheromone trail; and
generate, based on at least one of: the first usage score associated with the first digital pheromone trail or the first recency score, the first cluster for the first digital pheromone trail, wherein the first recency score exceeds a recency threshold score.

7. The system of claim 6, wherein the processing circuitry is further configured to utilize the function-specific agent for the determination of the first recommended usage pattern, and wherein the function-specific agent is configured to:
receive, from the cluster agent, at least one of: the first cluster or a set of metadata associated with the first cluster, wherein the set of metadata is indicative of a navigation pattern type indicated by the first cluster; and
determine the first recommended usage pattern based on at least one of: the first cluster or the set of metadata.

8. The system of claim 7, wherein the processing circuitry is further configured to utilize the visualization agent to render the first recommended usage pattern, and wherein the visualization agent is configured to:
generate, based on at least one of: the first recommended usage pattern or the navigation pattern type, a visualization interface that presents the first recommended usage pattern associated with at least the first digital artifact; and
render the visualization interface via the display device associated with the system.

9. The system of claim 8, wherein based on the navigation pattern type being a security navigation pattern type, the visualization agent is further configured to:
generate, based on the first recommended usage pattern, a heat map for at least the first digital artifact, wherein the heat map is indicative of a risk severity metric associated with at least the first digital artifact; and
render the heat map via the display device associated with the system.

10. The system of claim 4, wherein the processing circuitry is further configured to utilize the adaptive agent for generation of a query response to a user query, and wherein the adaptive agent is configured to:
access the user query associated with at least the first digital artifact;
determine a context associated with the user query;
generate, based on the context, a set of intermediate queries, wherein the set of intermediate queries, collectively, corresponds to the context associated with the user query;
communicate at least a subset of intermediate queries of the set of intermediate queries to at least one of: the navigator agent, the cluster agent, the visualization agent, or the function-specific agent;
receive at least a first portion associated with the query response from at least one of: the navigator agent, the cluster agent, the visualization agent, or the function-specific agent; and
generate, in response to the user query, the query response based on at least the first portion associated with the query response, wherein the visualization agent is configured to render the query response via the display device associated with the system.

11. The system of claim 1,
wherein the storage element is further configured to store the set of digital artifacts by way of a dependency graph with each digital artifact of the set of digital artifacts forming a node of the dependency graph, and
wherein an association between a first node of the dependency graph that represents at least the first digital artifact and a second node of the dependency graph that represents a second digital artifact of the set of digital artifacts is indicative of an association between at least the first digital artifact and the second digital artifact.

12. The system of claim 11, wherein the association between at least the first digital artifact and the second digital artifact corresponds to at least one of: a syntactic association or a semantic association.

13. The system of claim 11, wherein the processing circuitry is further configured to identify, based on the dependency graph, the second digital artifact associated with at least the first digital artifact, and wherein the first recommended usage pattern is determined further based on the second digital artifact.

14. The system of claim 4, wherein the first recommended usage pattern is associated with a function-specific score, and wherein the function-specific agent is configured to:
determine the function-specific score associated with the first recommended usage pattern; and
generate a set of feedback associated with the first recommended usage pattern based on the function-specific score, wherein the visualization agent is configured to render the set of feedback via the display device associated with the system.

15. The system of claim 1, wherein the first digital pheromone trail is associated with a pheromone type which corresponds to a navigation pattern type that is indicated by the first cluster, and
wherein the first cluster is generated further based on the pheromone type associated with the first digital pheromone trail.

16. The system of claim 1, wherein the processing circuitry is further configured to:
generate a second cluster for a second digital pheromone trail of the first set of digital pheromone trails based on the first usage score associated with the second digital pheromone trail exceeding the first threshold usage score, wherein the second cluster includes at least the first digital artifact;
determine, based on the second cluster, a second recommended usage pattern associated with at least the first digital artifact, wherein the second recommended usage pattern is indicative of a second navigation pattern, of the first set of navigation patterns, represented by the second digital pheromone trail; and
render, via the display device associated with the system, the second recommended usage pattern.

17. The system of claim 1, wherein the processing circuitry is further configured to:
determine a second plurality of operational attribute values for the plurality of operational attributes pertaining to each of a second plurality of operations associated with a third digital artifact of the set of digital artifacts;
generate, based on the second plurality of operational attribute values, a second set of digital pheromone trails associated with the third digital artifact, wherein the second set of digital pheromone trails represents a second set of navigation patterns associated with the third digital artifact;
determine, based on the second plurality of operational attribute values, a second usage score associated with each digital pheromone trail of the second set of digital pheromone trails, wherein the second usage score is indicative of traversal frequency of a navigation pattern associated with the digital pheromone trail;
generate a third cluster for a third digital pheromone trail of the second set of digital pheromone trails based on the second usage score associated with the third digital pheromone trail exceeding a second threshold usage score, wherein the third cluster includes the third digital artifact;
determine, based on the third cluster, a third recommended usage pattern associated with the third digital artifact, wherein the third recommended usage pattern is indicative of a third navigation pattern, of the second set of navigation patterns, represented by the third digital pheromone trail; and
render, via the display device associated with the system, the third recommended usage pattern.

18. A method, comprising:
determining, by processing circuitry, a first plurality of operational attribute values for a plurality of operational attributes pertaining to each of a first plurality of operations associated with at least a first digital artifact of a set of digital artifacts stored in a storage element;
generating, by the processing circuity, based on the first plurality of operational attribute values for the plurality of operational attributes pertaining to each of the first plurality of operations, a first set of digital pheromone trails associated with at least the first digital artifact, wherein the first set of digital pheromone trails represents a first set of navigation patterns associated with at least the first digital artifact;
determining, by the processing circuitry, based on the first plurality of operational attribute values, a first usage score associated with each digital pheromone trail of the first set of digital pheromone trails, wherein the first usage score is indicative of traversal frequency of a navigation pattern associated with the digital pheromone trail;
generating, by the processing circuitry, a first cluster for a first digital pheromone trail of the first set of digital pheromone trails based on the first usage score associated with the first digital pheromone trail exceeding a first threshold usage score, wherein the first cluster includes at least the first digital artifact;
determining, by the processing circuitry, based on the first cluster, a first recommended usage pattern associated with at least the first digital artifact, wherein the first recommended usage pattern is indicative of a first navigation pattern of the first set of navigation patterns represented by the first digital pheromone trail; and
rendering, by the processing circuitry, via a display device, the first recommended usage pattern.

19. The method of claim 18, wherein the determination of the first recommended usage pattern includes utilizing, by the processing circuitry, at least one of: a navigator agent, a cluster agent, a visualization agent, an adaptive agent, or a function-specific agent stored in the storage element.

20. A non-transitory computer-readable medium comprising instructions that, when executed by processing circuitry of a computing system, cause the computing system to perform a method for facilitating usage pattern recommendation for digital artifacts, the method comprising:
determining, by the processing circuitry, a first plurality of operational attribute values for a plurality of operational attributes pertaining to each of a first plurality of operations associated with at least a first digital artifact of a set of digital artifacts stored in a storage element;
generating, by the processing circuitry, based on the first plurality of operational attribute values for the plurality of operational attributes pertaining to each of the first plurality of operations, a first set of digital pheromone trails associated with at least the first digital artifact, wherein the first set of digital pheromone trails represents a first set of navigation patterns associated with at least the first digital artifact;
determining, by the processing circuitry, based on the first plurality of operational attribute values, a first usage score associated with each digital pheromone trail of the first set of digital pheromone trails, wherein the first usage score is indicative of traversal frequency of a navigation pattern associated with the digital pheromone trail;
generating, by the processing circuitry, a first cluster for a first digital pheromone trail of the first set of digital pheromone trails based on the first usage score associated with the first digital pheromone trail exceeding a first threshold usage score, wherein the first cluster includes at least the first digital artifact;
determining, by the processing circuitry, based on the first cluster, a first recommended usage pattern associated with at least the first digital artifact, wherein the first recommended usage pattern is indicative of a first navigation pattern of the first set of navigation patterns represented by the first digital pheromone trail; and
rendering, by the processing circuitry, via a display device, the first recommended usage pattern.
